(19) United States
(12) Patent Application Publication
(10) Pub. No.: US 2024/0199881 A1
(43) Pub. Date: Jun. 20, 2024

(54) METAL COMPLEX DYES FOR INKJET PRINTING

(71) Applicant: Videojet Technologies Inc., Wood Dale, IL (US)

(72) Inventors: Linfang Zhu, Wood Dale, IL (US); Wei Weng, Wood Dale, IL (US); Fengfei Xiao, Wood Dale, IL (US); Benjamin Studebaker, Wood Dale, IL (US)

(73) Assignee: Videojet Technologies Inc., Wood Dale, IL (US)

(21) Appl. No.: 18/431,843

(22) Filed: Feb. 2, 2024

Related U.S. Application Data
(63) Continuation of application No. PCT/US22/39151, filed on Aug. 2, 2022.
(60) Provisional application No. 63/229,334, filed on Aug. 4, 2021.

(51) Int. Cl. C09B 45/32; C07F 15/02; C09D 11/328

(52) U.S. Cl. CPC C09B 45/32; C07F 15/025; C09D 11/328

(57) ABSTRACT

This invention relates to metal complex dyes that are free of chromium, are not carcinogenic, mutagenic, or reproductive toxins. These dyes have good solubility and conductivity in organic solvents, chemical stability, and light stability. The invention also relates to a method of inkjet printing comprising using the ink compositions and ink cartridges.

### CROSS-REFERENCE TO RELATED APPLICATIONS

This application is a Continuation of International Application No. PCT/US2022/039151, filed on Aug. 2, 2022, which claims the benefit of and priority to U.S. Appl. No. 63/229,334 filed Aug. 4, 2021, each of which is incorporated herein by reference in their entirety for any and all purposes.

### BACKGROUND OF THE INVENTION

### 1. Field of the Invention

The invention pertains to metal complex dyes useful in inkjet printing. The invention specifically relates to metal complex dyes that are free of chromium III, which is a “carcinogen, mutagen or reproductive toxin (CMR).”

### 2. Background of the Invention

Chromium-based SB29 dye (Colour index C.I. Solvent Black 29) is widely used in ink jet ink formulations. SB29 has been classified as a reproductive toxin since 2018 based on regulatory data gathered for REACH registration at the 100 tonnage level. Although SB27 dye (Colour Index C.I. Solvent Black 27) currently is not classified as a reproductive toxin due to lower tonnage, it is not a long-term alternative for SB29 because there is a high risk that SB27 will be given the same classification in the next few years due to structural similarities. There is a need in the art for dyes that can be used in inkjet printing that do not use chromium-based dyes and are not a carcinogen, mutagen or reproductive toxin (CMR).

### SUMMARY OF THE INVENTION

Because Cr(III)-based SB29 is classified as a reproductive toxin and the structurally similar SB27 likely will also be so classified, new metal dyes that are chromium-free and non-toxic are needed in the art. The present invention therefore relates to new metal complex dyes that avoid chromium, while retaining the desirable functional properties of inks currently in use, such as good solubility and conductivity in organic solvents, chemical stability, and light stability.

The invention relates to an azo-metal complexed dye compound according to Formula I:

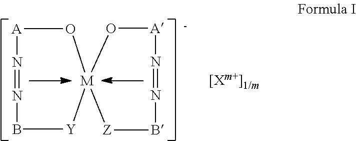

wherein M is any Group 3-13 metal in the 3+ oxidation state, with the proviso that the metal is not Cr(III);
wherein m is the net positive charge on the counter-cation, X.
wherein A and A′ independently are optionally substituted phenylene or naphthylene;
wherein B and B′ independently are optionally substituted phenylene or naphthylene;
wherein Y and Z independently are either —O— or —NR¹—; wherein X is a hydrogen ion (H⁺), an alkali metal ion, a primary ammonium ion (NH₃R⁴⁺), a secondary ammonium ion (NH₂R⁴R⁵⁺), a tertiary ammonium ion (NHR⁴R⁵R⁶⁺), or a quaternary ammonium ion (NR⁴R⁵R⁶R⁷⁺);
wherein R¹ is
   (i) hydrogen;
   (ii) a linear, branched or cyclic (C₁-C₁₈) alkyl group, optionally substituted, and optionally containing unsaturated bonds, which contains 0-9 heteroatoms selected from O, N, and S;
   (iii) an unsubstituted or substituted aryl, heteroaryl, arylalkyl, heteroarylalkyl, alkylaryl or alkylheteroaryl, wherein the alkyl groups in the arylalkyl, heteroarylalkyl, alkylaryl or alkylheteroaryl moieties are linear, branched or cyclic (C₁-C₁₈) alkyl groups, optionally containing unsaturated bonds, optionally containing 0-9 heteroatoms selected from O, N and S, and optionally containing one or more functional groups selected from —N₂, —OR², —NR²R³, —CN, —I, —Br, —F, —Cl, —C(O)R², and —CO₂R²;
wherein R² and R³ independently are as defined for R¹, or R² and R³ also may be joined to form a cyclic structure;
wherein R⁴, R⁵, R⁶, and R⁷ independently are
   (i) a hydrogen atom;
   (ii) a linear, branched or cyclic (C₁-C₁₈) alkyl group, optionally substituted with substituted and unsubstituted alkyl groups, and optionally containing unsaturated bonds;
   (iii) a linear, branched, or cyclic (C₁-C₁₈) hetero alkyl group, optionally substituted with substituted and unsubstituted alkyl groups, wherein the hetero atoms are selected from the group consisting of oxygen, nitrogen, sulfur, and silicon, and optionally containing unsaturated bonds;
   (iv) an arylalkyl group wherein the alkyl portion of the arylalkyl group is a linear, branched, or cyclic (C₁-C₁₈) alkyl group, optionally substituted with substituted and unsubstituted alkyl groups, and optionally containing unsaturated bonds;
   (v) a hetero arylalkyl group optionally substituted with substituted and unsubstituted alkyl groups, wherein the hetero atoms are selected from the group consisting of oxygen, nitrogen, sulfur, and silicon;
   (vi) an alkylaryl group wherein the alkyl portion of the arylalkyl group is a linear, branched, or cyclic (C₁-C₁₈) alkyl group, optionally substituted with substituted and unsubstituted alkyl groups, and optionally containing unsaturated bonds;
   (vii) a hetero alkylaryl group optionally substituted with substituted and unsubstituted alkyl groups, wherein the hetero atoms are selected from the group consisting of oxygen, nitrogen, sulfur, and silicon; and
   (viii) two or more of R⁴, R⁵, and R⁶ optionally are joined to form a cyclic structure.

In some embodiments, the invention relates to an azo-metal complexed dye compound of Formula I or of claim 1, selected from the group consisting of:

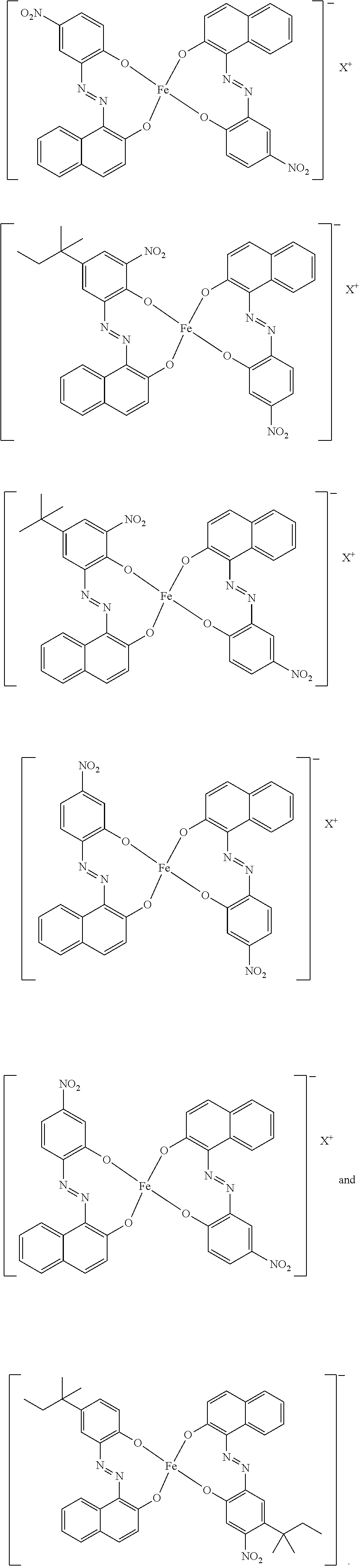

wherein X is a hydrogen ion, an alkali metal ion, a primary ammonium ion, a secondary ammonium ion, a tertiary ammonium ion, or a quaternary ammonium ion.

In certain specific embodiments, the invention relates to an azo-metal complexed dye compound of Formula I or of claim 1, selected from the group consisting of:

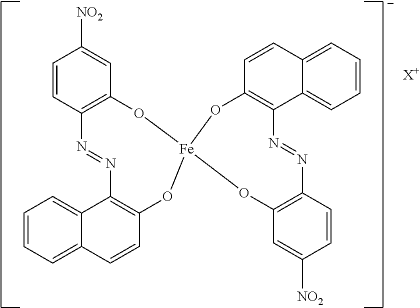

wherein X is a hydrogen ion, an alkali metal ion, a primary ammonium ion, a secondary ammonium ion, a tertiary ammonium ion, or a quaternary ammonium ion.

In other specific embodiments, the invention relates to an azo-metal complexed dye compound of Formula I or of claim 1, selected from the group consisting of:

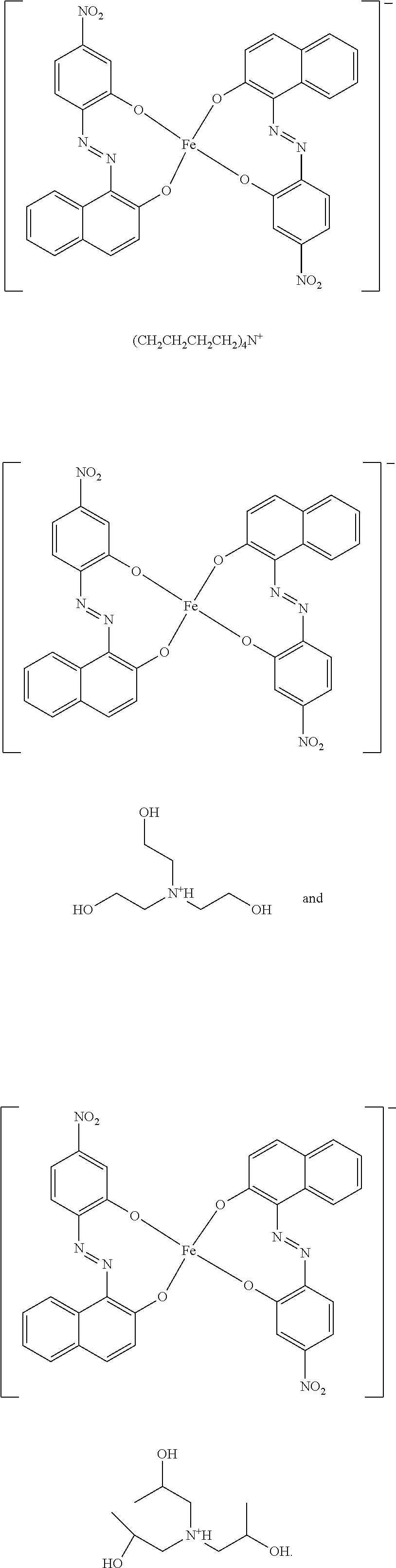

In some embodiments, the invention includes an azo-metal complexed dye compound of claim 1 wherein M is a transition metal in the +3 oxidation state or Al(III). Preferably, M is selected from the group consisting of Fe(III), Al(III), V(III), Mn(III), and Co(III). In some preferred embodiments, M is Fe(III).

In certain embodiment described above, Y and Z are —O—.

In certain other embodiments, X is selected from the group consisting of Na+, a secondary amine, a tertiary amine and a quaternary amine. Preferred azo-metal complexed dye compounds are those wherein X is selected from the group consisting of methylamine, ethylamine, propylamine, isopropylamine, butylamine, sec-butylamine, isobutylamine, pentylamine, tert-pentylamine, 2-aminopentane, 3-aminopentane, 1,2-dimethylpropylamine, mixed isomers of amylamines, hexylamine, heptylamine, 2-ethylhexylamine, octylamine, nonylamine, decylamine, dodecylamine, ethanolamine, propanolamine; isopropanolamine, dimethylamine, diethylamine, dipropylamine, diisopropylamine, diebutylamine, diethanolamine, dipropanolamine, diisopropanolamine, trimethylamine, triethylamine, tripropylamine, tributylamine, triethylamineethanolamine, tri-propanolamine, tri-iso-propanolamine, 2-(2-aminoethoxy)ethanol, tetraethylammonium, tetrabutylammonium, tetrapropylammonium, tetrapentylammonium, tetrahexylammonium, tetraoctylammonium, tetradecylammonium, tetradodecylammonium, tridodecylmethylammonium, dodecyltrimethylammonium, trioctylmethylammonium, benzyltriethylammonium, N-methylethanolamine, N,N-dimethyl-1-propanamine, N,N-dimethylethanolamine, N,N-diisopropylethanolamine, and N,N,N-trimethylethanolamine (choline).

In some embodiments, the azo-metal complexed dye compounds are those wherein A and A′ independently are selected from the group consisting of

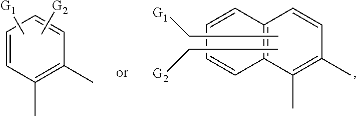

wherein G¹ is hydrogen, halogen, CN, NO₂, CF₃, OR¹, C(O)R⁸, or CO₂R⁸; and G² is hydrogen, halogen, NO₂, linear, branched or cyclic (C₁-C₁₈) alkyl, optionally containing unsaturated bonds and, unsubstituted or substituted aryl or heteroaryl; and wherein R⁸ is hydrogen, optionally substituted linear, branched or cyclic (C₁-C₈) alkyl, optionally substituted aryl or heteroaryl, benzyl, or phenethyl. Preferably, the azo-metal complexed dye compounds are those wherein G¹ is Cl or NO₂, and G² is hydrogen, NO₂ or a saturated, linear or branched (C₁-C₈) alkyl.

As such, in certain preferred compounds, the A and A′ groups especially derive from the following o-aminophenols: 2-amino-4-nitrophenol, 2-amino-5-nitrophenol, 2-amino-3,5-dinitrophenol, picramic acid, 2-amino-4-(tert-butyl)-6-nitrophenol, 2-amino-6-nitro-4-(tert-pentyl)phenol, and 2-amino-6-nitro-4-(1,1,3,3-tetramethylbutyl)phenol.

In some embodiments, the azo-metal complexed dye compounds are those wherein B and B′ independently are

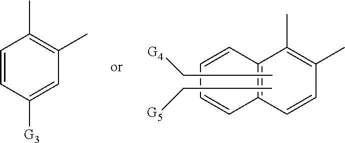

wherein G³ is R¹, halogen; OR¹; NR²R³; G⁴ and G⁵ independently are halogen, hydrogen linear, branched or cyclic (C₁-C₁₈) alkyl, optionally containing unsaturated bonds linear, branched or cyclic (C₁-C₁₈) alkyl, optionally containing unsaturated bonds; or unsubstituted or substituted aryl or heteroaryl. G⁴ and G⁵ preferably are —OR¹, —CO₂R¹, —NR²R³, —NR¹C(O)R⁸, or NR¹C(O)OR⁸.

As such, in preferred compounds, G³ is NR²R³, or naphthalene wherein G⁴ is hydrogen, CO₂R⁸, CONHR⁸, OR⁸, NHC(O)R⁸, NHC(O)OR⁸, or substituted or unsubstituted saturated linear or branched (C₁-C₈) alkyl, wherein R⁸ is selected from the group consisting of hydrogen, optionally substituted linear, branched or cyclic (C₁-C₈) alkyl, or optionally substituted aryl or heteroaryl.

The invention also comprises azo-metal complexed dye compositions comprising an azo-metal complex dye compound as described herein and a solvent or solvents, or suspending agent. The compositions also include azo-metal complexed dye compositions comprising one or more azo-metal complex dye compounds and water, a solvent, or a suspending agent.

The invention also comprises water or solvent based ink compositions comprising an azo-metal complexed dye compound as described above, and ink cartridges comprising the ink compositions.

The invention also relates to a method of inkjet printing comprising using the ink compositions and ink cartridges as discussed above.

### DETAILED DESCRIPTION

### 1. DEFINITIONS

Unless defined otherwise, all technical and scientific terms used herein have the same meaning as commonly understood by one of ordinary skill in the art. Although various methods and materials similar or equivalent to those described herein can be used in the practice or testing of the present invention, suitable methods and materials are described below. However, the skilled artisan understands that the methods and materials used and described are examples and may not be the only ones suitable for use in the invention. Moreover, as measurements are subject to inherent variability, any temperature, weight, volume, time interval, pH, salinity, molarity or molality, range, concentration and any other measurements, quantities or numerical expressions given herein are intended to be approximate and not exact or critical figures unless expressly stated to the contrary.

The term “about,” as used herein, means plus or minus 20 percent of the recited value, so that, for example, “about 0.125” means 0.125±0.025, and “about 1.0” means 1.0±0.2.

The term “transition metal” refers to an element with a partially filled d sub-shell, or which can give rise to cations with an incomplete d sub-shell. These metals generally are known in the art as those elements in groups 3 to 12 on the periodic table.

The term “alkali metal” refers to a metal of Group I(A) of the periodic table, including lithium, sodium, potassium, rubidium, cesium and francium.

### 2. ADVANTAGES

A key advantage of the present invention over the 1:1 azo/metal complex dyes disclosed in U.S. Pat. Nos. 5,314,998 and 7,157,563 is that the 2:1 azo/metal complex dyes disclosed and claimed here are more stable than the prior art dyes, hence less likely to lose color and to fail filterability testing during the life of the product. The other advantage is that the 2:1 complex dyes disclosed as embodiments of this invention are conductive and can serve the dual purpose of a colorant and a conductive agent while the 1:1 azo/metal complex dyes are not conductive so additional conductive agent is required for CIJ ink jet compositions.

Another advantage of the present invention over prior art U.S. Pat. No. 5,677,434 is improved dye solubility in organic solvents such as MEK and ethanol. Organic primary, secondary, tertiary, and quaternary ammonium salts of the 2:1 azo/metal complex dyes disclosed in this invention are more organic-soluble than the 2:1 azo/metal complex with cations H⁺, a metal ion, or NH₄⁺ as disclosed in the prior art. Hence embodiments of this invention are more suitable for fast dry solvent-based ink jet ink formulations. In addition, the cations disclosed in this invention are less hydrophilic than the cations disclosed in the prior art and are more condensation resistant in applications such as “cold-fill.” In some applications, such as the beverage industry. a liquid product is often filled into a container when the product is cold (“cold-fill”). A layer of condensation often forms on the outer surface of the filled container, especially in a humid environment. Therefore, the ink used for printing onto the container surface needs to have sufficient resistance to condensation.

### 3. EMBODIMENTS OF THE INVENTION

The inks according to embodiments of the invention use one or more transition or other metals in place of Cr(III), which has the potential to be oxidized to Cr(VI), a carcinogen and reproductive toxin. Such metals for use in the invention include, but are not limited to, any of the Group 3-12 transition metals which are known in the art, with the exception of Cr(III), or Group 13 metals. Preferred metals are Fe(III), Al(III), V(III), Mn(III), and Co(III). The most preferred metal for use in the present invention is Fe(III). The counterion preferably is an organic ammonium cation such as tetrabutylammonium, a protonated form of triethanolamine, or triisopropanolamine. Prior dyes such as SB29, contain a branched long chain alkyl primary ammonium cation. The cations disclosed and claimed here can provide better solubility in a various organic solvents such as ketones, esters, and alcohols and are potentially safer than the ammonium cation in SB29.

The general structure of embodiments of the inventive azo-metal dye compounds are the azo-metal complex dyes as represented by Formula I, below. In these compounds, two azo dyes are co-ordinated to one metal, hence this structure may be referred to as a 2:1 complex. The 2:1 complex carries an overall anionic charge, and has 1/m associated counter-cations X, where m is the net positive charge on the associated counter-cation.

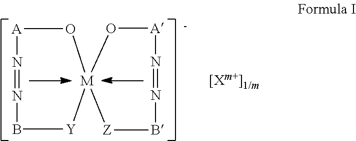

wherein M is any Group 3-13 metal in the 3+ oxidation state, with the proviso that the metal is not Cr(III);
wherein m is the net positive charge on the counter-cation, X.
wherein A and A′ independently are optionally substituted phenylene or naphthylene;
wherein B and B′ are independently are optionally substituted phenylene or naphthylene;
wherein Y and Z independently are either —O— or —NR¹—;
wherein X is a hydrogen ion (H⁺), an alkali metal ion, a primary ammonium ion (NH₃R⁴⁺), a secondary ammonium ion (NH₂R⁴R⁵⁺), a tertiary ammonium ion (NHR⁴R⁵R⁶⁺), or a quaternary ammonium ion (NR⁴R⁵R⁶R⁷⁺);
wherein R¹ is
   (i) hydrogen;
   (ii) a linear, branched or cyclic (C₁-C₁₈) alkyl group, optionally substituted, and optionally containing unsaturated bonds, which contains 0-9 heteroatoms selected from O, N, and S;
   (iii) an unsubstituted or substituted aryl, heteroaryl, arylalkyl, heteroarylalkyl, alkylaryl or alkylheteroaryl, wherein the alkyl groups in the arylalkyl, heteroarylalkyl, alkylaryl or alkylheteroaryl moieties are linear, branched or cyclic (C₁-C₁₈) alkyl groups, optionally containing unsaturated bonds, optionally containing 0-9 heteroatoms selected from O, N and S, and optionally containing one or more functional groups selected from —NO₂, —OR², —NR²R³, —CN, —I, —Br, —F, —Cl, —C(O)R², and —CO₂R²;
wherein R² and R³ independently are as defined for R¹, or R² and R³ also may be joined to form a cyclic structure;
wherein R⁴, R⁵, R⁶, and R⁷ independently are
   (i) a hydrogen atom;
   (ii) a linear, branched or cyclic (C₁-C₁₈) alkyl group, optionally substituted with substituted and unsubstituted alkyl groups, and optionally containing unsaturated bonds;
   (iii) a linear, branched, or cyclic (C₁-C₁₈) hetero alkyl group, optionally substituted with substituted and unsubstituted alkyl groups, wherein the hetero atoms are selected from the group consisting of oxygen, nitrogen, sulfur, and silicon, and optionally containing unsaturated bonds;
   (iv) an arylalkyl group wherein the alkyl portion of the arylalkyl group is a linear, branched, or cyclic (C₁-C₁₈) alkyl group, optionally substituted with substituted and unsubstituted alkyl groups, and optionally containing unsaturated bonds;
   (v) a hetero arylalkyl group optionally substituted with substituted and unsubstituted alkyl groups, wherein the hetero atoms are selected from the group consisting of oxygen, nitrogen, sulfur, and silicon;
   (vi) an alkylaryl group wherein the alkyl portion of the arylalkyl group is a linear, branched, or cyclic (C₁-C₁₈) alkyl group, optionally substituted with substituted and unsubstituted alkyl groups, and optionally containing unsaturated bonds;
   (vii) a hetero alkylaryl group optionally substituted with substituted and unsubstituted alkyl groups, wherein the hetero atoms are selected from the group consisting of oxygen, nitrogen, sulfur, and silicon; and wherein
   (viii) two or more of R⁴, R⁵, and R⁶ optionally are joined to form a cyclic structure.

Preferably, the aryl, heteroaryl, arylalkyl, heteroarylalkyl, alkylaryl or alkylheteroaryl group is selected from tolyl, benzyl, penethyl and the like. Optionally, the alkyl, arylalkyl, and alkylaryl groups of Formula I are additionally substituted with one or more hydroxy groups, halogen atoms, amine groups, imine groups, ammonium groups, cyano groups, pyridine groups, pyridinium groups, ether groups, aldehyde groups, ketone groups, ester groups, amide groups, carbonyl groups, thiocarbonyl groups, sulfide groups, sulfoxide groups, phosphine groups, phosphonium groups, phosphate groups, nitrile groups, mercapto groups, nitro groups, nitroso groups, sulfone groups, acyl groups, azo groups, cyanato groups, carboxylate groups, carboxylic acid groups, urethane groups, urea groups, and the like.

Preferred complexed metals M are transition metals such as Co(III), V(III), Mn(III), Fe(III) and the non-transition metal Al(III). Fe(III) is especially preferred.

Preferred A and A′ moieties are

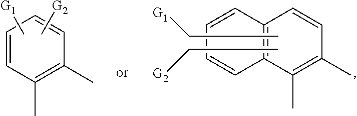

wherein G¹ is hydrogen, halogen, CN, NO₂, CF₃, OR¹, C(O)R⁸, or CO₂R⁸; and G² is hydrogen, halogen, NO₂, linear, branched or cyclic (C₁-C₁₈) alkyl, optionally containing unsaturated bonds and, unsubstituted or substituted aryl or heteroaryl; and wherein R⁸ is hydrogen, optionally substituted linear, branched or cyclic (C₁-C₈) alkyl, or optionally substituted aryl or heteroaryl, benzyl or phenethyl.

Preferred B and B′ moieties are

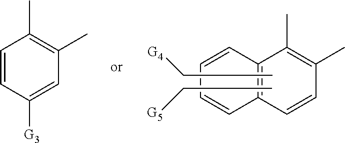

wherein G³ is R¹, halogen; OR¹; NR²R³; G⁴ and G⁵ independently are halogen, hydrogen linear, branched or cyclic (C₁-C₁₈) alkyl, optionally containing unsaturated bonds linear, branched or cyclic (C₁-C₁₈) alkyl, optionally containing unsaturated bonds; or unsubstituted or substituted aryl or heteroaryl. G⁴ and G⁵ preferably are —OR¹, —CO₂R¹, —NR²R³, —NR¹C(O)R⁸, or NR¹C(O)OR⁸ wherein R⁸ is as defined above.

Preferred Y and Z are —O—.

Especially preferred structures of A and A′ are phenylene, substituted independently with G¹ and G² groups, where G¹ is Cl or NO₂, and G² is hydrogen, NO₂ or saturated, linear or branched (C₁-C₈) alkyl. As such, A and A′ especially derive from the following o-aminophenols: 2-amino-4-nitrophenol, 2-amino-5-nitrophenol, 2-amino-3,5-dinitrophenol, picramic acid, 2-amino-4-(tert-butyl)-6-nitrophenol, 2-amino-6-nitro-4-(tert-pentyl)phenol, and 2-amino-6-nitro-4-(1,1,3,3-tetramethylbutyl)phenol.

Especially preferred structures of B and B′ are phenylene wherein G³ is NR²R³, or naphthalene wherein G⁴ is hydrogen, CO₂R⁸, CONHR⁸, OR⁸, NHC(O)R⁸, NHC(O)OR⁸, or substituted or unsubstituted saturated linear or branched (C₁-C₈) alkyl. As such, B and B′ especially derive from the following aminophenols or naphthols: 3-(dimethylamino)phenol, 3-(diethylamino)phenol, 3-(dipropylamino)phenol, 3-(dibutylamino)phenol, 3-(dioctylamino)phenol, 2-naphthol, methyl 3-hydroxy-2-naphthoate, ethyl 3-hydroxy-2-naphthoate, 6-bromo-2-naphthol, N-(7-hydroxynaphthalen-1-yl)acetamide, methyl (7-hydroxynaphthalen-1-yl)carbamate, 7-methoxy-2-naphthol, 6-methyl-2-naphthol, 6-ethyl-2-naphthol, 6-tert-butyl-2-naphthol, 6-(1,1,3,3-tetramethylbutyl)-2-naphthalenol 6-tert-pentyl-2-naphthol.

Preferred X counter-cations are Na⁺ and secondary, tertiary and quaternary ammonium ions. In certain embodiments, preferable ammonium counter-cations are R⁴R⁵R⁶R⁷N⁺, wherein R⁴, R⁵, R⁶ and R⁷ independently are (i) a hydrogen atom where at least one of R⁴, R⁵, R⁶ and R⁷ is not hydrogen; (ii) a linear, branched or cyclic (C₁-C₁₈) alkyl group optionally substituted with alkyl groups an optionally containing one or more hetero atoms selected from oxygen, nitrogen, sulfur, and silicon; (iii) an optionally substituted aryl (C₁-C₁₈) linear, branched or cyclic alkyl group optionally containing one or more hetero atoms selected from oxygen, nitrogen, sulfur, and silicon; or (iv) an optionally substituted, linear, branched or cyclic (C₁-C₁₈) alkyl aryl group optionally containing one or more hetero atoms selected from oxygen, nitrogen, sulfur, and silicon. The substituents on the substituted alkyl, arylalkyl, and alkylaryl groups include but are not limited to: hydroxy groups, halogen atoms, amine groups, imine groups, ammonium groups, cyano groups, pyridine groups, pyridinium groups, ether groups, aldehyde groups, ketone groups, ester groups, amide groups, carbonyl groups, thiocarbonyl groups, sulfide groups, sulfoxide groups, phosphine groups, phosphonium groups, phosphate groups, nitrile groups, mercapto groups, nitro groups, nitroso groups, sulfone groups, acyl groups, azo groups, cyanato groups, carboxylate groups, carboxylic acid groups, urethane groups, urea groups, and mixtures thereof.

In certain embodiments, referred X groups are primary, secondary and tertiary and quaternary ammonium groups, which are protonated (H) forms of the primary, secondary, and tertiary amines. Examples of suitable secondary and tertiary amines include but are not limited to: methylamine, ethylamine, propylamine, isopropylamine, butylamine, sec-butylamine, isobutylamine, pentylamine, tert-pentylamine, 2-aminopentane, 3-aminopentane, 1,2-dimethylpropylamine, mixed isomers of amylamines, hexylamine, heptylamine, 2-ethylhexylamine, octylamine, nonylamine, decylamine, dodecylamine, ethanolamine, propanolamine; isopropanolamine, dimethylamine, diethylamine, dipropylamine, diisopropylamine, diebutylamine, diethanolamine, dipropanolamine, diisopropanolamine, trimethylamine, triethylamine, tripropylamine, tributylamine, triethylamineethanolamine, tri-propanolamine, tri-iso-propanolamine, 2-(2-aminoethoxy)ethanol. Examples of suitable quaternary ammonium counterions include but are not limited to: tetraethylammonium, tetrabutylammonium, tetrapropylammonium, tetrapentylammonium, tetrahexylammonium, tetraoctylammonium, tetradecylammonium, tetradodecylammonium, tridodecylmethylammonium, dodecyltrimethylammonium, trioctylmethylammonium, benzyltriethylammonium. Mixed secondary and tertiary ammonium ions also can be used, and include but are not limited to pronated forms of N-methylethanolamine, N,N-dimethyl-1-propanamine, N,N-dimethylethanolamine, and N,N-diisopropylethanolamine. Mixed quaternary ammonium also can be used, including but not limited to N,N,N-trimethylethanolamine (choline).

In Formula I, A, B, A′ and B′ are moieties that can be installed through azo-coupling chemistry, as is known in the art and described in, for example, Organic Chemistry in Colour, P. F. Gordon and P. Gregory, Springer-Verlag Berlin Heidelberg 1987, DOI: 10.1007/978-3-642-82959-8; Section 2.4, page 57-65. A and A′ originate as (hetero)aryl-amine compounds (diazo components) that can be diazotised to diazonium salts, and B and B′ originate as compounds that can couple with diazonium salts (couplers). A and A′ can be identical to each other or different to each other, and B and B′ can be identical to each other or different to each other.

Compounds of Formula I can be and have been prepared using a metalation reaction. The metalation reaction involves adding a metal salt (M³⁺) to azo dyes that have suitable groups to bind to the metal (see Formula II and Formula II′, below). The metal binding groups are hydroxy functions on A and A′, and a group Y—H on B and Z—H on B′. One metal ion combines with 2 azo dye molecules to give the 2:1 complex of Formula I.

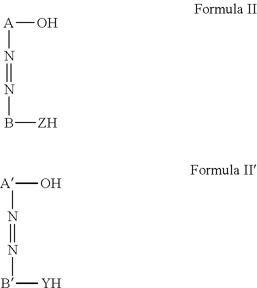

Depending on the number of different variants of Formula II and Formula II′ which are added in the metalation reaction, the produced material will be comprised of a mixture of n(n+1)/2 unique Formula I components where n is the number of different variants of Formula II added in the metalation reaction. The following schemes illustrate metalation reactions where n=1 and n=2. In this scheme, the counterion X is omitted for clarity. In practice, an acid binder is added to consume the generated acid, which is also omitted in the scheme.

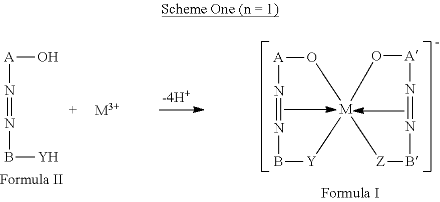

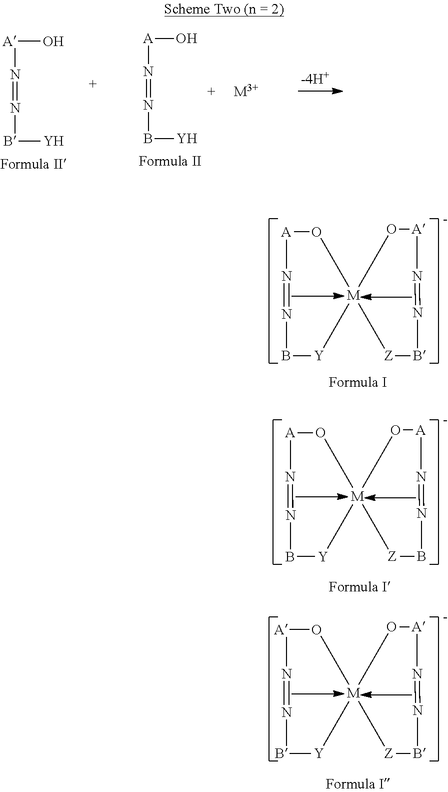

When n=1 (i.e., one Formula II variant), one compound according to Formula I is formed. When n=2 (i.e., two Formula II variants), three compounds according to Formula I are formed.

The invention also relates to dye compositions that contain the azo-metal complex dye compounds described herein with a solvent or suspending agent. Solvents that are suitable for these compositions include water and organic solvents. Preferred solvents include, but are not limited to ketones (e.g., acetone, methyl ethyl ketone (butanone), methyl n-propyl ketone (2-pentanone), diethyl ketone (3-pentanone), methyl isopropyl ketone (3-methyl-2-butanone), and cyclohexanone); alcohols (e.g., methanol, ethanol, n-propanol, iso-propanol, and n-butanol); esters (e.g., methyl acetate, ethyl acetate, n-propyl acetate, iso-propyl acetate, n-butyl acetate, and t-butyl acetate); and other solvents such as dimethyl carbonate, propylene carbonate, ethers, glycols, glycol ethers, diacetone alcohol, and the like. The most preferred solvents are C3-C6 ketones such as acetone, methyl ethyl ketone, methyl n-propyl ketone, diethyl ketone and methyl isopropyl ketone; C2-C3 alcohols such as ethanol, n-propanol, iso-propanol; and C3-C5 esters such as methyl acetate, ethyl acetate, n-propyl acetate, and iso-propyl acetate.

The compositions can optionally include both a solvent and a suspending agent, or can include a mixture of solvents.

The invention also relates to an ink composition comprising the azo-metal complexed dyes described here and a solvent, including water or an organic solvent, or a mixture of solvents and/or suspending agents.

The invention also relates to an ink cartridge containing the above ink compositions and a method of inkjet printing using the ink compositions above. The invention is useful for inkjet printing.

### 4. EXAMPLES

This invention is not limited to the particular processes, compositions, or methodologies described, as these may vary. The terminology used in the description is for the purpose of describing the particular versions or embodiments only, and is not intended to limit the scope of the present invention which will be limited only by the appended claims. Although any methods and materials similar or equivalent to those described herein can be used in the practice or testing of embodiments of the present invention, the preferred methods, devices, and materials are now described. All publications mentioned herein, are incorporated by reference in their entirety; nothing herein is to be construed as an admission that the invention is not entitled to antedate such disclosure by virtue of prior invention.

### Example 1: Synthesis of 1-((2-Hydroxy-4-nitrophenyl)diazenyl)naphthalen-2-ol

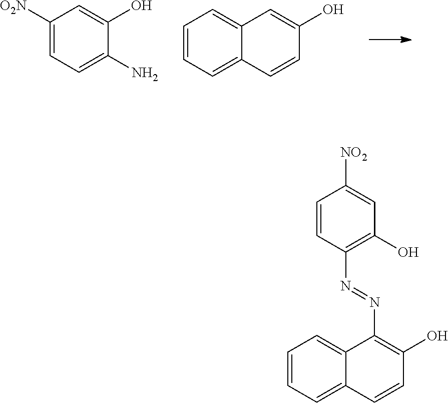 [SMILES: Nc1ccc([N+](=O)[O-])cc1O ; Oc1ccc2ccccc2c1 ; O=[N+]([O-])c1ccc(/N=N/c2c(O)ccc3ccccc23)c(O)c1]

To a stirred suspension of 2-amino-5-nitrophenol (274.4 g, 1.78 mol) in water (2.75 L) was added a 37% HCl solution (526.5 g, 5.34 mol). The mixture was cooled to 0° C. and a solution of sodium nitrite (126.5 g, 1.83 mol) in water (250 ml) was added at <10° C. to give an orange suspension. The mixture was stirred at <10° C. until TLC indicated that all 2-amino-5-nitrophenol had been consumed, at which point, excess nitrous acid was quenched by the addition of a solution of sulfamic acid (8.64 g, 0.09 mol) in water (86 g). This mixture was transferred by peristaltic pump to a solution at 5° C. of 2-naphthol (269.6 g, 1.87 mol), which had been pre-dissolved in water (2.70 L) at pH 13.0 through the addition of 50% NaOH liquor. As the pH fell, further 50% NaOH liquor was added by automated pH dependent dosing pump to maintain a pH of 10; the mixture was transferred at such a rate that the temperature did not exceed 10° C. throughout the addition. The mixture was stirred for several hours and allowed to warm to ambient temperature until the pH stabilized at pH 10 without further addition of alkali. A thick black suspension was formed. To this suspension was then added 37% HCl solution until the pH stabilized at pH 2.0, causing a color change from a black to red suspension. The suspended solid was collected by filtration and washed well with water to remove residual salts. The solid was dried to constant weight in a vacuum oven at 70° C. to yield 463 g of 1-((2-hydroxy-4-nitrophenyl)diazenyl)naphthalen-2-ol as a dark red powder.

### Example 2. Synthesis of 1-((2-Hydroxy-5-nitrophenyl)diazenyl)naphthalen-2-ol

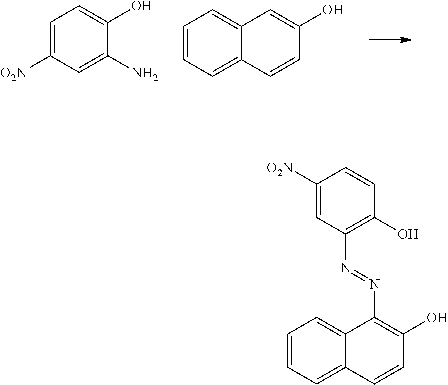 [SMILES: Nc1cc([N+](=O)[O-])ccc1O ; Oc1ccc2ccccc2c1 ; O=[N+]([O-])c1ccc(O)c(/N=N/c2c(O)ccc3ccccc23)c1]

The methodology of Example 1 was followed, except 2-amino-5-nitrophenol was replaced with 2-amino-4-nitrophenol. When 15.4 g of 2-amino-4-nitrophenol was used, 24.1 g of 1-((2-hydroxy-5-nitrophenyl)diazenyl)naphthalen-2-ol was obtained as an orange solid.

### Example 3. Synthesis of 1-((2-Hydroxy-5-chlorophenyl)diazenyl)naphthalen-2-ol

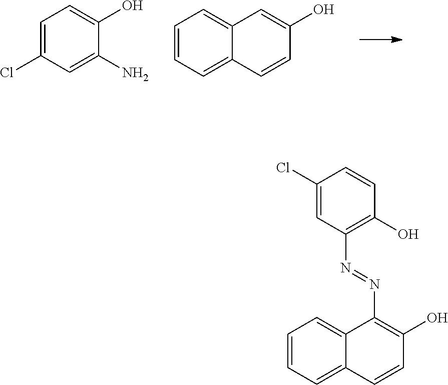 [SMILES: Nc1cc(Cl)ccc1O ; Oc1ccc2ccccc2c1 ; Oc1ccc(Cl)cc1/N=N/c1c(O)ccc2ccccc12]

The methodology of Example 1 was followed, except 2-amino-5-nitrophenol was replaced with 2-amino-4-chlorophenol. When 14.4 g of 2-amino-4-chlorophenol was used, 27.4 g of 1-((2-hydroxy-5-chlorophenyl)diazenyl)naphthalen-2-ol was obtained as a red solid.

### Example 4. Synthesis of N-(7-hydroxy-8-((2-hydroxy-4-nitrophenyl)diazenyl)naphthalen-1-yl)acetamide

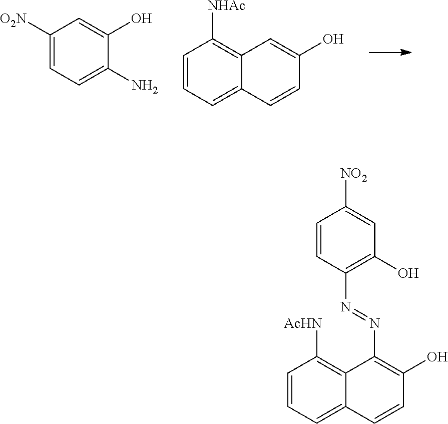 [SMILES: Nc1ccc([N+](=O)[O-])cc1O ; CC(=O)Nc1cccc2ccc(O)cc12 ; CC(=O)Nc1cccc2ccc(O)c(/N=N/c3ccc([N+](=O)[O-])cc3O)c12]

The methodology of Example 1 was followed, except 2-naphthol was replaced with N-(7-hydroxynaphthalen-1-yl)acetamide. When 7.3 g of 2-amino-5-nitrophenol was used, 9.4 g of N-(7-hydroxy-8-((2-hydroxy-4-nitrophenyl)diazenyl)naphthalen-1-yl)acetamide was obtained as a red solid.

### Example 5. Synthesis of 5-(Diethylamino)-2-((2-hydroxy-4nitrophenyl)diazenyl)phenol

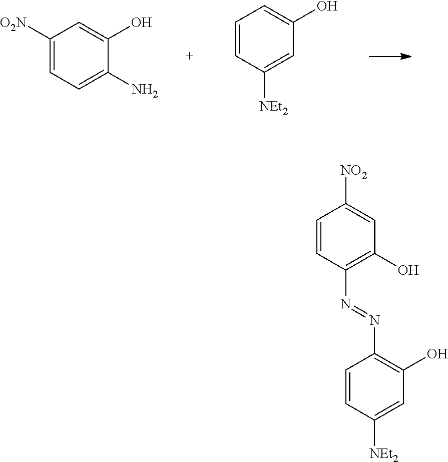

2-Amino-5-nitrophenol (9.9 g, 0.065 mol) was suspended with stirring in water and 37% HCl (19.0 g, 0.194 mol) added. The mixture was cooled to <5° C. and a solution of sodium nitrite (4.6 g, 0.067 mol) in water (10 ml) was added at <10° C. to give an orange suspension. The mixture was stirred at <10° C. until TLC indicated that all 2-amino-5-nitrophenol had been consumed, at which point, excess nitrous acid was quenched by the addition of a solution of sulfamic acid (0.4 g, 0.004 mol) in water (4 g). 3-(Diethylamino)phenol (11.2 g, 0.068 mol) was dissolved in water (110 ml) by acidification with 37% HCl (8.0 g, 0.081 mol) and cooled to 5° C. before adding to the reaction. Sodium acetate solution was added to raise to pH 5 and the reaction was then heated to 40° C. overnight. The suspended solid was collected by filtration and washed copiously with water to remove dissolved salts. The filter cake was slurried and stirred in methanol for 2 hours, retrieved by filtration, and washed on the filter with 2×100 ml methanol. The filter cake was dried to constant weight in a vacuum oven at 70° C. to yield 30.9 g of 5-(diethylamino)-2-((2-hydroxy-4-nitrophenyl)diazenyl)phenol as a dark brown solid.

### Example 6. Synthesis of 1-((2-Hydroxy-3-nitro-5-(tert-pentyl)phenyl)diazenyl)naphthalen-2-ol

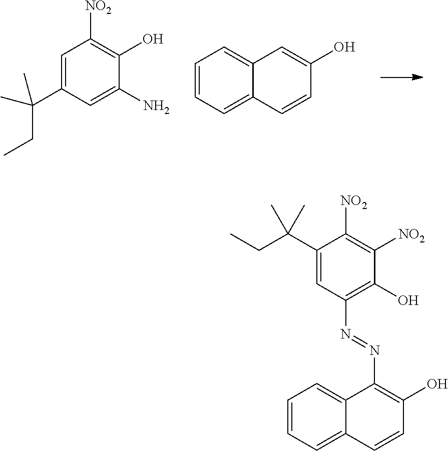 [SMILES: CCC(C)(C)c1cc(N)c(O)c([N+](=O)[O-])c1 ; Oc1ccc2ccccc2c1 ; CCC(C)(C)c1cc(/N=N/c2c(O)ccc3ccccc23)c(O)c([N+](=O)[O-])c1[N+](=O)[O-]]

The methodology of Example 1 was followed, except 2-amino-5-nitrophenol was replaced with 2-amino-6-nitro-4-(tert-pentyl)phenol. When 23.5 g of 2-amino-6-nitro-4-(tert-pentyl)phenol was used, 35.0 g of 1-((2-hydroxy-3-nitro-5-(tert-pentyl)phenyl)diazenyl)naphthalen-2-ol was obtained as a red solid.

### Example 7. Exemplary Synthesis of Metal Complexed Azo Dyes

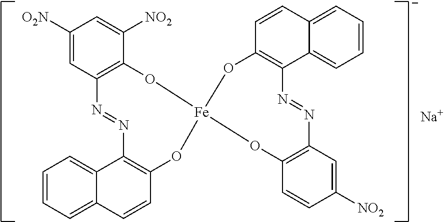

A mixture of 1-((2-hydroxy-5-nitrophenyl)diazenyl)naphthalen-2-ol (0.31 g), vanadium(III) acetylacetanoate (0.19 g), sodium acetate trihydrate (0.68 g), water (4.6 ml) and ethylene glycol monomethyl ether (4.6 ml) was heated for 6 hours at reflux then allowed to cool to room temperature before recovering the precipitated solid by filtration and washing with water on the filter. The solid was dried in a vacuum oven at 70° C. to give a red-black powder. When dissolved in acetone, the product gave a deep red coloured solution with λₘₐₓ 541 nm.

### Examples 8-26. Synthesis of Exemplary Metal Complexed Azo Dyes

Using the stated azo-dyes (prepared in Examples 1-6, and the stated metal salts, and by following methodology described in Example 7, the following materials were prepared. See Table 1, below.

TABLE 1
Exemplary Metal Complexed Azo Dyes.

| Example | | | | λₘₐₓ |
|---|---|---|---|---|
| No. | Azo dye | Metal salt | Product | (acetone) |
| 8 | 1-((2-hydroxy-5- nitrophenyl)diazenyl) naphthalen-2-ol | Aluminium acetate, basic | 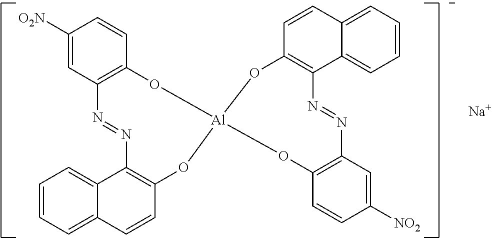 | 544 nm |
| 9 | 1-((2-hydroxy-5- nitrophenyl)diazenyl) naphthalen-2-ol | Ammonium iron(III) sulfate dodecahydrate | 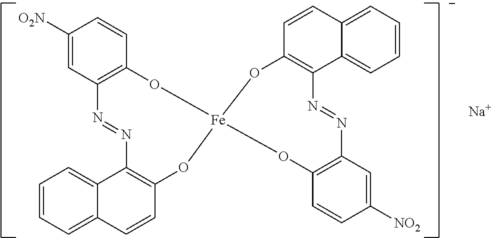 | 393 nm/ 478 nm |
| 10 | 1-((2-hydroxy-5- nitrophenyl)diazenyl) naphthalen-2-ol | Manganese(III) triacetate dihydrate | 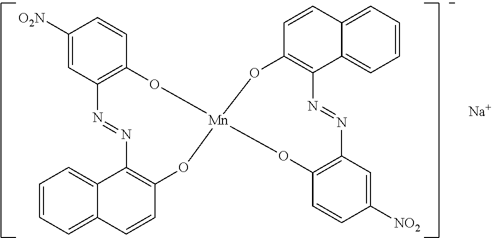 | 585 nm |
| 11 | 1-((2-hydroxy-5- nitrophenyl)diazenyl) naphthalen-2-ol | Cobalt(III) acetylacetonate | 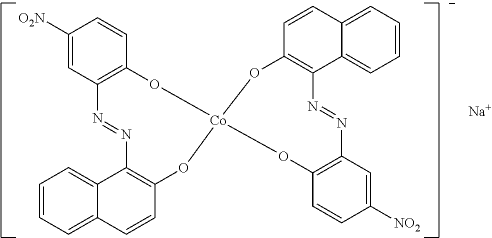 | 566 nm |
| 12 | 1-((2-Hydroxy-4- nitrophenyl)diazenyl) naphthalen-2-ol | vanadium(III) acetylacetanoate | 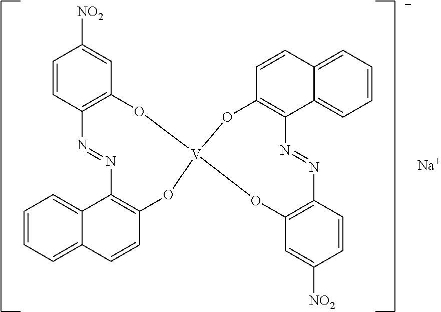 | 557 nm |
| 13 | 1-((2-Hydroxy-4- nitrophenyl)diazenyl) naphthalen-2-ol | Aluminium acetate, basic | 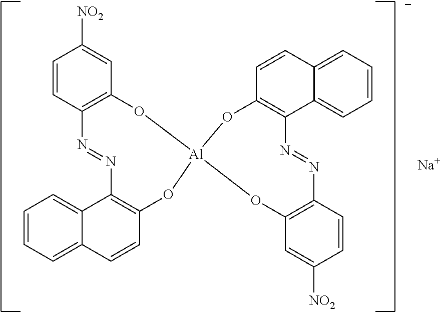 | 580 nm |
| 14 | 1-((2-Hydroxy-4- nitrophenyl)diazenyl) naphthalen-2-ol | Manganese(III) triacetate dihydrate | 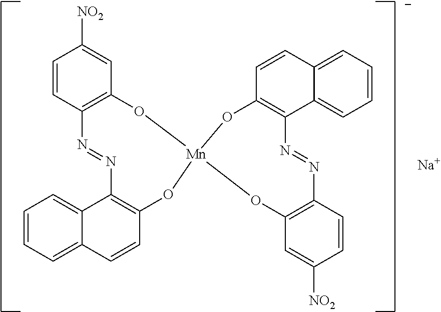 | 515 nm |
| 15 | 1-((2-Hydroxy-4- nitrophenyl)diazenyl) naphthalen-2-ol | Cobalt(III) acetylacetonate | 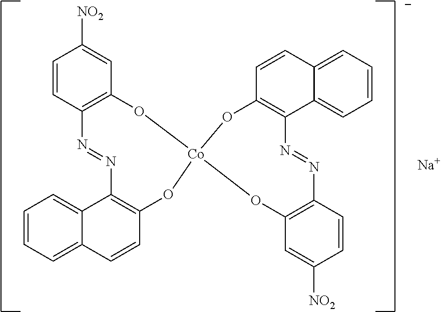 | 599 nm |
| 16 | 1-((2-Hydroxy-5- chlorophenyl)diazenyl) naphthalen-2-ol | Vanadium(III) acetylacetanoate | 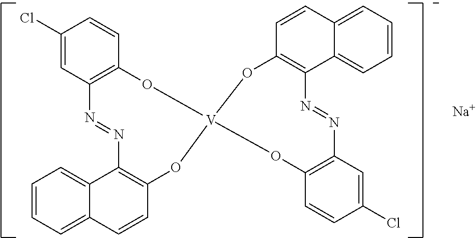 | 528 nm |
| 17 | 1-((2-Hydroxy-5- chlorophenyl)diazenyl) naphthalen-2-ol | Aluminium acetate, basic | 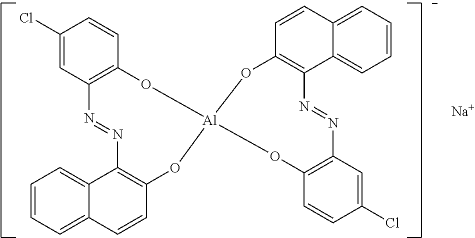 | 562 nm |
| 18 | 1-((2-Hydroxy-5- chlorophenyl)diazenyl) naphthalen-2-ol | Ammonium iron(III) sulfate dodecahydrate | 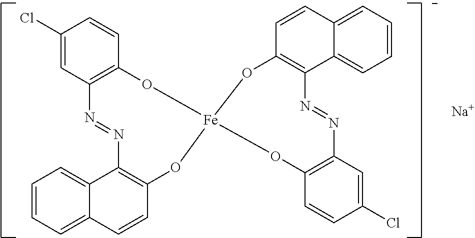 | 461 nm |
| 19 | 1-((2-Hydroxy-5- chlorophenyl)diazenyl) naphthalen-2-ol | Manganese(III) triacetate dihydrate | 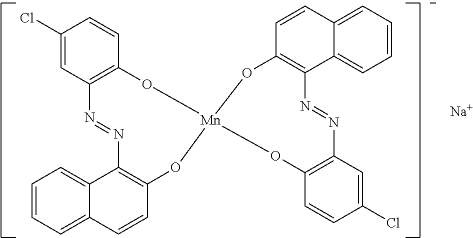 | 489 nm |
| 20 | 1-((2-Hydroxy-5- chlorophenyl)diazenyl) naphthalen-2-ol | Cobalt(III) acetylacetonate | 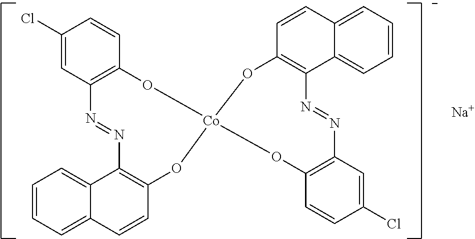 | 573 nm |
| 21 | N-(7-Hydroxy-8- ((2-hydroxy-4- nitrophenyl)diazenyl) naphthalen-1- yl)acetamide | Aluminium acetate, basic | 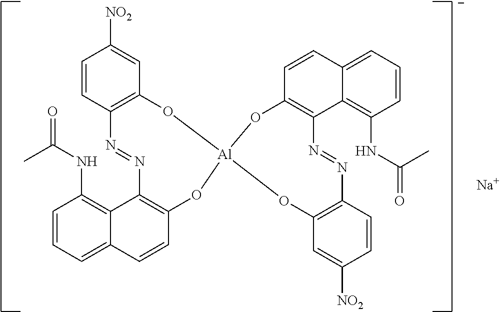 | 602 nm |
| 22 | N-(7-Hydroxy-8- ((2-hydroxy-4- nitrophenyl)diazenyl) naphthalen-1- yl)acetamide | Ammonium iron(III) sulfate dodecahydrate | 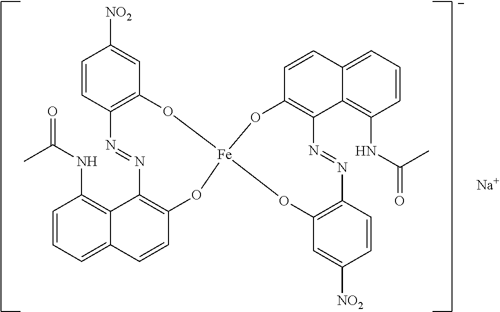 | 523 nm |
| 23 | 5-(Diethylamino)- 2-((2-hydroxy-4- nitrophenyl)diazenyl) phenol | Vanadium(III) acetylacetanoate | 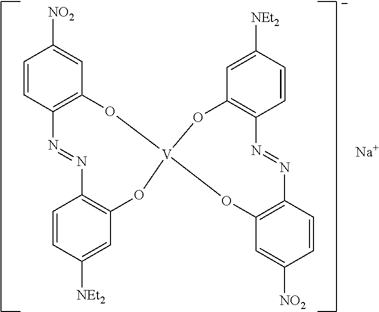 | 547 nm |
| 24 | 5-(Diethylamino)- 2-((2-hydroxy-4- nitrophenyl)diazenyl) phenol | Aluminium acetate, basic | 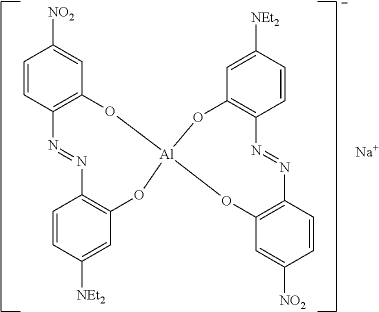 | 557 nm |
| 25 | 5-(Diethylamino)- 2-((2-hydroxy-4- nitrophenyl)diazenyl) phenol | Ammonium iron(III) sulfate dodecahydrate | 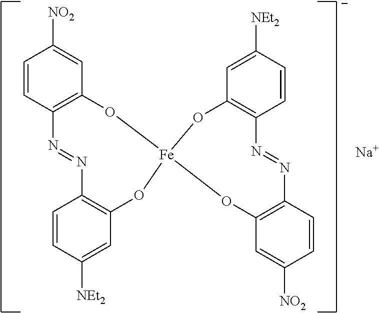 | 497 nm |
| 26 | 5-(Diethylamino)- 2-((2-hydroxy-4- nitrophenyl)diazenyl) phenol | Cobalt(III) acetylacetonate | 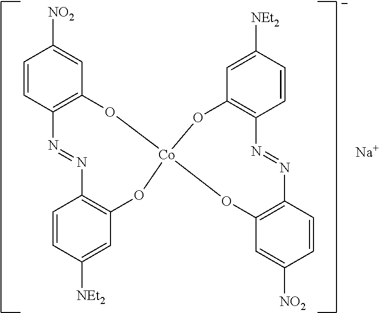 | 595 nm |

### Example 27. Synthesis of Exemplary Metal Complexed Azo Dye

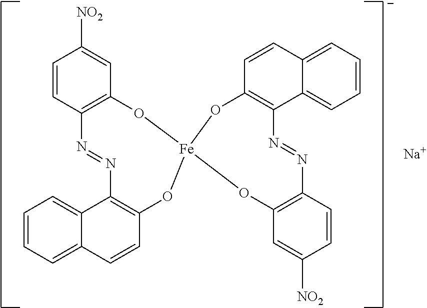

A mixture of 1-((2-hydroxy-4-nitrophenyl)diazenyl)naphthalen-2-ol (154.6 g), ammonium iron(III) sulfate dodecahydrate (81.0 g), iron(III) chloride hexahydrate (45.4 g), sodium acetate trihydrate (340.2 g), water (1150 ml) and 1-propanol (1150 ml) was heated for 12 hours at reflux then approximately half the solvent was removed by vacuum distillation at 70° C. The resulting suspended solid was filtered and washed copiously on the filter with water. The solid was dried in a vacuum oven at 70° C. to give a black powder. When dissolved in acetone, the product absorbed visible light between 350-780 nm, with λₘₐₓ 497 nm.

### Example 28. Synthesis of Exemplary Metal Complexed Azo Dye

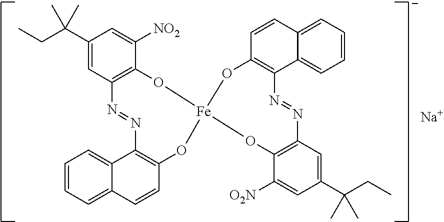

A mixture of 1-((2-hydroxy-3-nitro-5-(tert-pentyl)phenyl)diazenyl)naphthalen-2-ol (1.52 g), iron(III) chloride (0.37 g), 49% sodium hydroxide (0.72 g), water (27 ml) and 1-butanol (6 ml) was heated for 12 hours at reflux then approximately half the solvent was removed by vacuum distillation at 70° C. The resultant suspended solid was retrieved by filtration and washed copiously on the filter with water. The solid was dried in a vacuum oven at 70° C. to give a black powder. When dissolved in acetone, the product gave a red-brown coloured solution, which absorbed visible light between 350-780 nm, with λₘₐₓ 495 nm.

### Example 29. Synthesis of Exemplary Metal Complexed Azo Dye

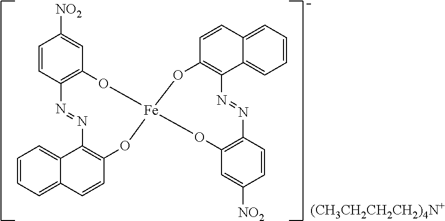

A mixture of the iron complex sodium salt prepared according to Example 27 (156 g), tetra-n-butylammonium bromide (72.5 g) and acetone (1560 ml) was stirred overnight at 40° C. The undissolved sodium bromide was removed by filtration and the filtrates were evaporated. Drying in a vacuum oven at 70° C. afforded 185 g of the tetra-n-butylammonium salt as a black solid, which was ground to a fine powder. When dissolved in acetone, the product had an identical UV-vis absorbance spectrum to the sodium salt described in Example 27, but was tinctorially weaker (w/w) due to the higher molecular weight of the counterion.

### Example 30. Synthesis of Exemplary Metal Complexed Azo Dye

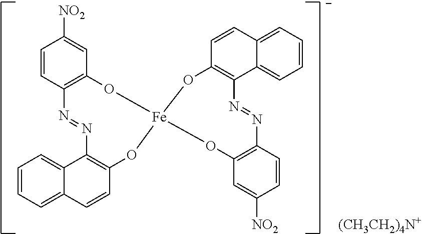

A mixture of 1-((2-hydroxy-4-nitrophenyl)diazenyl)naphthalen-2-ol (2.32 g), iron(III) sulfate hydrate (74.2% assay, 1.13 g), 35% tetraethylammonium hydroxide (6.31 g) in water, water (46 ml) and 1-butanol (5 ml) was heated at reflux until TLC showed that all 1-((2-hydroxy-4-nitrophenyl)diazenyl)naphthalen-2-ol had been complexed. Then, approximately 10 ml of solvent was removed by vacuum distillation at 70° C. and the remainder allowed to cool to ambient temperature. Methanol (10 ml) was added and the mixtures stirred until the solid was well dispersed. The suspended solid was retrieved by filtration and washed copiously on the filter with water. The solid was dried in a vacuum oven at 70° C. to give a black solid. When dissolved in acetone, the product had an identical UV-vis absorbance spectrum to the sodium salt described in Example 27, but was tinctorially weaker (w/w) due to the higher molecular weight of the counterion.

### Examples 31-58. Synthesis of Exemplary Metal Complexed Azo Dyes

According to the methodology described in Example 30, the following materials listed in Table 2, below, were prepared by using an equimolar amount the base stated in place of 35% tetraethylammonium hydroxide. When dissolved in acetone, the products had an identical UV-vis absorbance spectrum to the sodium salt described in Example 27. but were tinctorially weaker (w/w) due to the higher molecular weight of the counterion.

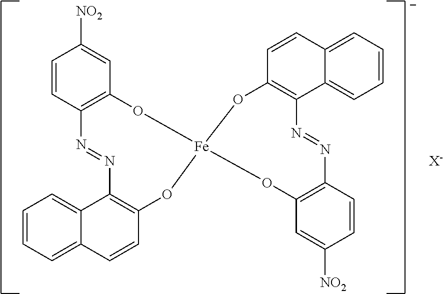

TABLE 2
Exemplary Azo Dyes.

| Example | | |
|---|---|---|
| No. | Base | X⁺ |
| 31 | Ethanolamine | 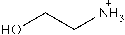 |
| 32 | Propanolamine | 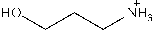 |
| 33 | 1,4-Diazabicyclo[2.2.2]octane | 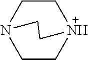 |
| 34 | 2-(2-(3- Aminopropoxy)ethoxy)ethanol | 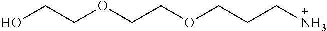 |
| 35 | 2-Amino-2-methyl-1-propanol | 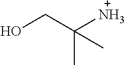 |
| 36 | 1-Amino-2-propanol | 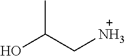 |
| 37 | 3-Aminopropane-1,2-diol | 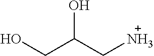 |
| 38 | Triethanolamine | 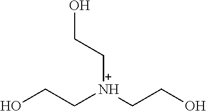 |
| 39 | Diisopropanolamine | 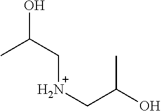 |
| 40 | Diethanolamine | 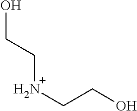 |
| 41 | 2-(2-Aminoethoxy)ethanol | 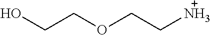 |
| 42 | 45% Choline hydroxide in water | 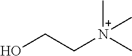 |
| 43 | Triisopropanolamine | 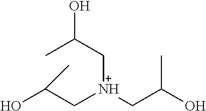 |
| 44 | 1-Piperidineethanol | 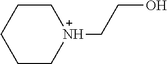 |
| 45 | Triethylamine | (CH₃CH₂)₃NH⁺ |
| 46 | Tributylamine | (CH₃CH₂CH₂CH₂)₃NH⁺ |
| 47 | 2-Ethylhexylamine | 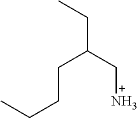 |
| 48 | Bis(2-ethylhexyl)amine | 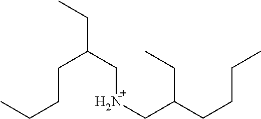 |
| 49 | Dibutylamine | (CH₃CH₂CH₂CH₂)₂NH₂⁺ |
| 50 | n-Decylamine | n-C₁₀H₂₁NH₃⁺ |
| 51 | n-Dodecylamine | n-C₁₂H₂₅NH₃⁺ |
| 52 | Tridecylamine (branched and straight | C₁₃H₂₇NH₃⁺ (branched/straight chain + |
| | chain mixture, containing some lower | homologues) |
| | and higher carbon chain homologues) | |
| 53 | 3-((2-Ethylhexyl)oxy)propan-1-amine | 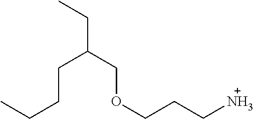 |
| 54 | 1,4-Bis(2-hydroxyethyl)piperazine | 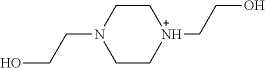 |
| 55 | N,N,N′,N′-Tetrakis(2- hydroxypropyl)ethylenediamine | 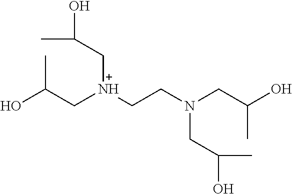 |
| 56 | N,N,N′,N′-Tetrakis(2- hydroxyethyl)ethylenediamine | 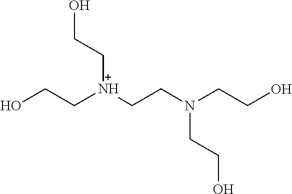 |
| 57 | 2-Amino-2-methyl-1,3-propanediol | 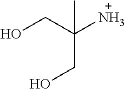 |
| 58 | 4-(2-Hydroxyethyl)morpholine | 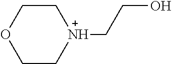 |

### Example 59. Synthesis of Exemplary Metal Complexed Azo Dye

According to the methodology described in Example 30, the following material was prepared by using an equimolar amount of triethanolamine in place of 35% tetraethylammonium hydroxide, an equimolar amount of iron(III) chloride in place of iron(III) sulfate hydrate and an equimolar amount of 1-((2-hydroxy-5-nitrophenyl)diazenyl)naphthalen-2-ol in place of 1-((2-hydroxy-4-nitrophenyl)diazenyl)naphthalen-2-ol. When dissolved in acetone, the product had an identical UV-vis absorbance spectrum to the sodium salt described in Example 9, but was tinctorially weaker w/w due to the higher molecular weight of the counterion.

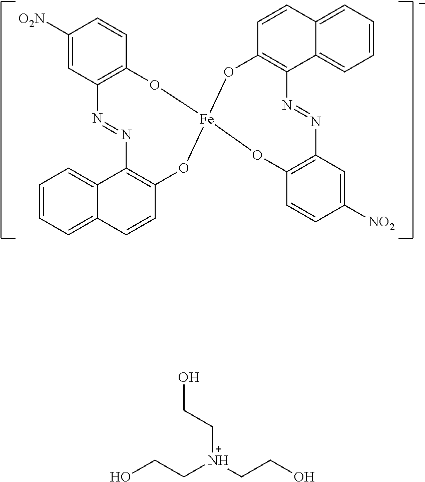

### Example 60. Synthesis of Exemplary Metal Complexed Azo Dye

According to the methodology described in Example 28, the following material was prepared by using an equimolar amount of triethanolamine in place of 49% sodium hydroxide and an equimolar amount of 1-((2-hydroxy-3-nitro-5-(tert-pentyl)phenyl)diazenyl)naphthalen-2-ol in place of 1-((2-hydroxy-4-nitrophenyl)diazenyl)naphthalen-2-ol. When dissolved in acetone, the product had an identical UV-vis absorbance spectrum to the sodium salt described in Example 28, but was tinctorially weaker w/w due to the higher molecular weight of the counterion.

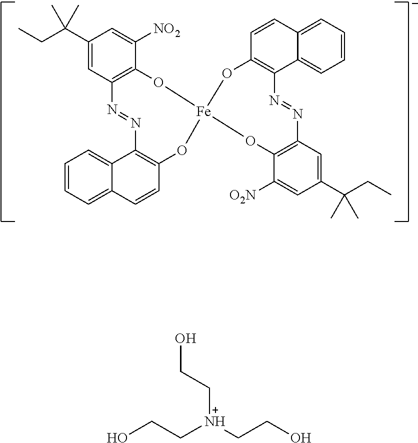

### Example 61. Visible Light Absorption by Metal Complex Dye Examples

According to the methodology described in Example 59, but by replacing 50% by moles of 1-((2-hydroxy-5-nitrophenyl)diazenyl)naphthalen-2-ol with 1-((2-hydroxy-4-nitrophenyl)diazenyl)naphthalen-2-ol, a mixture was prepared containing the three materials listed in Table 3, below. When dissolved in acetone, the product mixture absorbed visible light between 350-780 nm, with λₘₐₓ 481 nm.

TABLE 3
Metal Dye Examples.

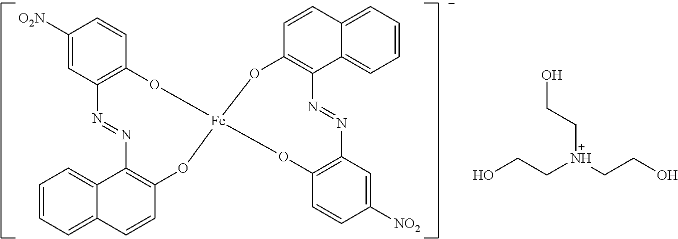

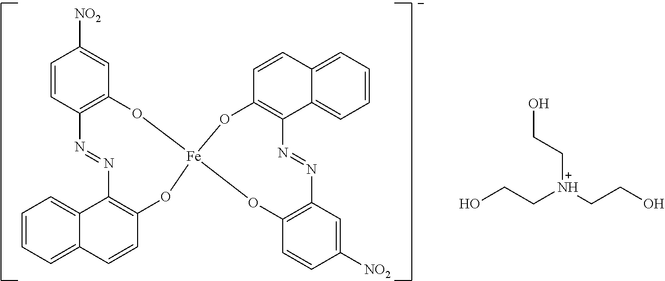

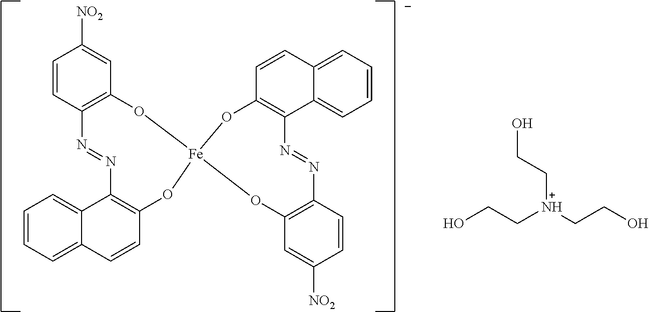

### Example 62. Visible Light Absorption in Metal Complex Dye Examples

According to the methodology described in Example 59, but by replacing 64% (by mole) of 1-((2-hydroxy-5-nitrophenyl)diazenyl)naphthalen-2-ol with 40% (by mole) of 1-((2-hydroxy-4-nitrophenyl)diazenyl)naphthalen-2-ol and 24% (by mole) of 1-((2-hydroxy-3-nitro-5-(tert-pentyl)phenyl)diazenyl)naphthalen-2-ol, a mixture was prepared containing the six metal dye materials shown in Table 4, below. When dissolved in acetone, the product mixture absorbed visible light between 350-780 nm, with λₘₐₓ 489 nm.

TABLE 4
Exemplary Metal Dye Materials.

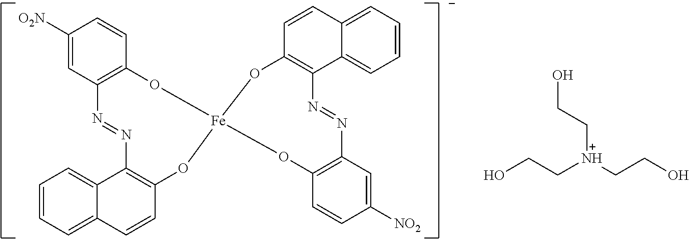

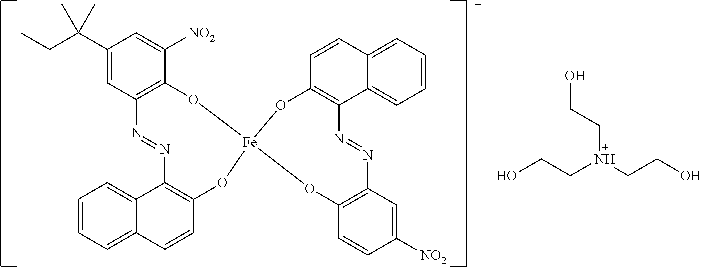

C

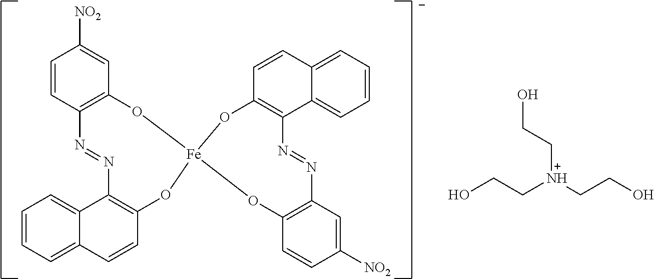

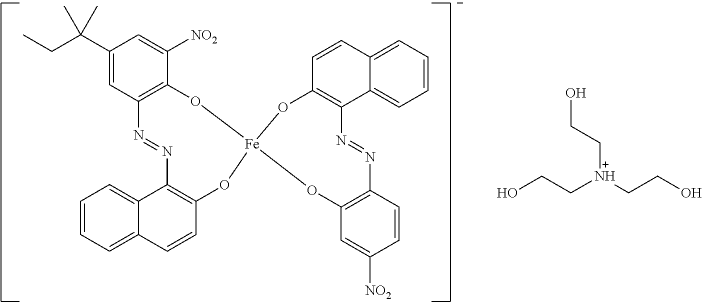

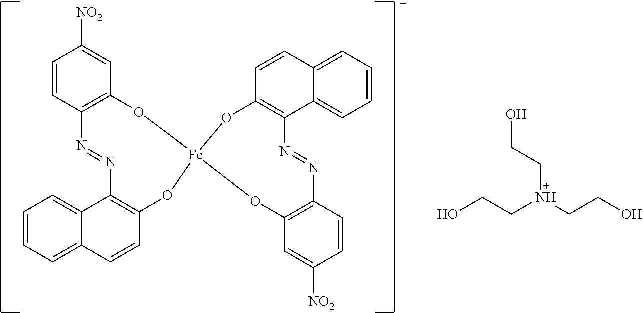

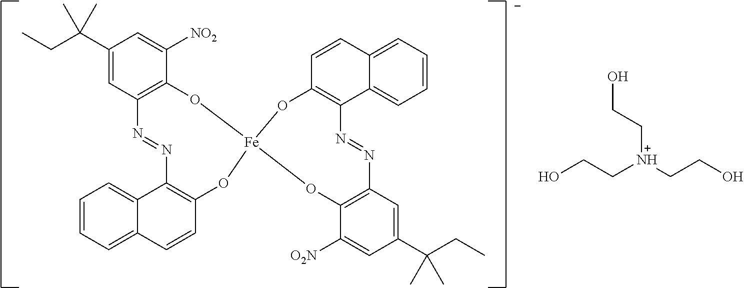

### Example 63. Saturated Solubility Testing

The saturated solubility of some materials was determined in butanone and ethanol. The results are shown below in Table 5. Benefits were observed with the materials containing a mixture of components compared to those components on their own.

TABLE 5
Saturated Solubility of Example Dyes.

| Example | Solubility (w/w) | Solubility (w/w) |
|---|---|---|
| No. | in butanone | in ethanol |
| 29 | 50% | <1% |
| 38 | 9% | 6% |
| 59 | 6% | <1% |
| 60 | ≥20% | <2% |
| 61 | 15% | 3% |
| 62 | ≥20% | ≥20% |

### 5. CLAUSES OF THE INVENTION

Clause 1. An azo-metal complexed dye compound according to Formula I:

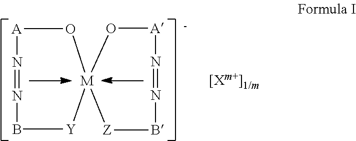

wherein M is any Group 3-13 metal in the 3+ oxidation state, with the proviso that the metal is not Cr(III);
wherein m is the net positive charge on the counter-cation, X.
wherein A and A′ independently are optionally substituted phenylene or naphthylene;
wherein B and B′ independently are optionally substituted phenylene or naphthylene;
wherein Y and Z independently are either —O— or —NR¹—;
wherein X is a hydrogen ion (H⁺), an alkali metal ion, a primary ammonium ion (NH₃R⁴⁺), a secondary ammonium ion (NH₂R⁴R⁵⁺), a tertiary ammonium ion (NHR⁴R⁵R⁶⁺), or a quaternary ammonium ion (NR⁴R⁵R⁶R⁷⁺);
wherein R¹ is
   (i) hydrogen;
   (ii) a linear, branched or cyclic (C₁-C₁₈) alkyl group, optionally substituted, and optionally containing unsaturated bonds, which contains 0-9 heteroatoms selected from O, N, and S;
   (iii) an unsubstituted or substituted aryl, heteroaryl, arylalkyl, heteroarylalkyl, alkylaryl or alkylheteroaryl, wherein the alkyl groups in the arylalkyl, heteroarylalkyl, alkylaryl or alkylheteroaryl moieties are linear, branched or cyclic (C₁-C₁₈) alkyl groups, optionally containing unsaturated bonds, optionally containing 0-9 heteroatoms selected from O, N and S, and optionally containing one or more functional groups selected from —NO₂, —OR², —NR²R³, —CN, —I, —Br, —F, —Cl, —C(O)R², and —CO₂R²;
wherein R² and R³ independently are as defined for R¹, or R² and R³ also may be joined to form a cyclic structure;
wherein R⁴, R⁵, R⁶, and R⁷ independently are
   (i) a hydrogen atom;
   (ii) a linear, branched or cyclic (C₁-C₁₈) alkyl group, optionally substituted with substituted and unsubstituted alkyl groups, and optionally containing unsaturated bonds;
   (iii) a linear, branched, or cyclic (C₁-C₁₈) hetero alkyl group, optionally substituted with substituted and unsubstituted alkyl groups, wherein the hetero atoms are selected from the group consisting of oxygen, nitrogen, sulfur, and silicon, and optionally containing unsaturated bonds;
   (iv) an arylalkyl group wherein the alkyl portion of the arylalkyl group is a linear, branched, or cyclic (C₁-C₁₈) alkyl group, optionally substituted with substituted and unsubstituted alkyl groups, and optionally containing unsaturated bonds;
   (v) a hetero arylalkyl group optionally substituted with substituted and unsubstituted alkyl groups, wherein the hetero atoms are selected from the group consisting of oxygen, nitrogen, sulfur, and silicon;
   (vi) an alkylaryl group wherein the alkyl portion of the arylalkyl group is a linear, branched, or cyclic (C₁-C₁₈) alkyl group, optionally substituted with substituted and unsubstituted alkyl groups, and optionally containing unsaturated bonds;
   (vii) a hetero alkylaryl group optionally substituted with substituted and unsubstituted alkyl groups, wherein the hetero atoms are selected from the group consisting of oxygen, nitrogen, sulfur, and silicon; and
   (viii) two or more of R⁴, R⁵, and R⁶ optionally are joined to form a cyclic structure.

Clause 2. An azo-metal complexed dye compound of clause 1 selected from the group consisting of:

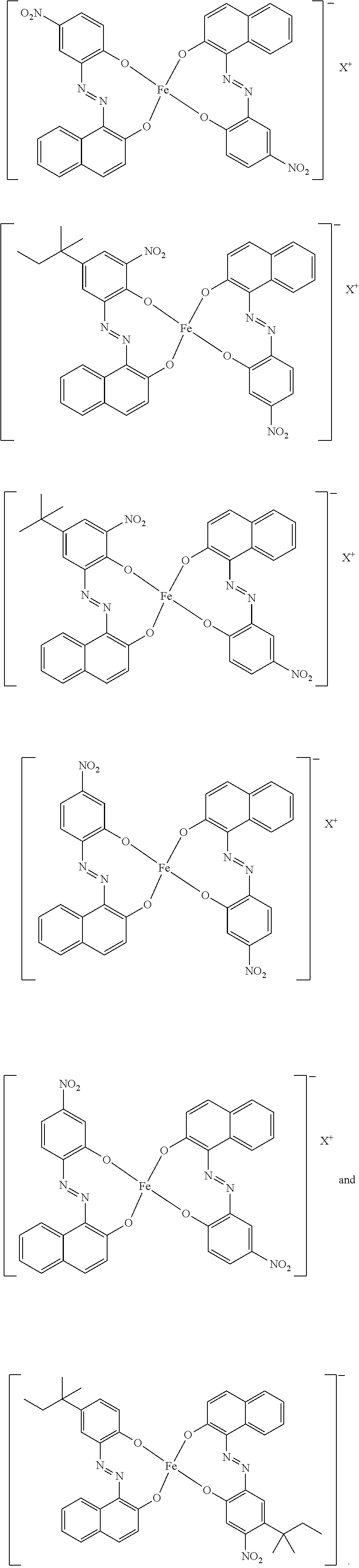

wherein X is a hydrogen ion, an alkali metal ion, a primary ammonium ion, a secondary ammonium ion, a tertiary ammonium ion, or a quaternary ammonium ion.

Clause 3. An azo-metal complexed dye compound of clause 1 or clause 2 selected from the group consisting of:

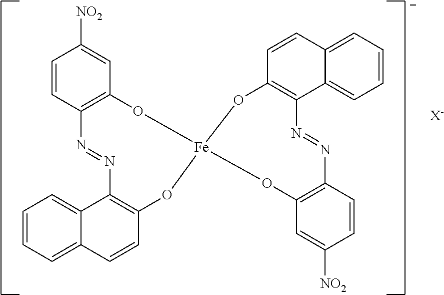

wherein X is a hydrogen ion, an alkali metal ion, a primary ammonium ion, a secondary ammonium ion, a tertiary ammonium ion, or a quaternary ammonium ion.

Clause 4. An azo-metal complexed dye compound of any one of clauses 1 to 3 selected from the group consisting of:

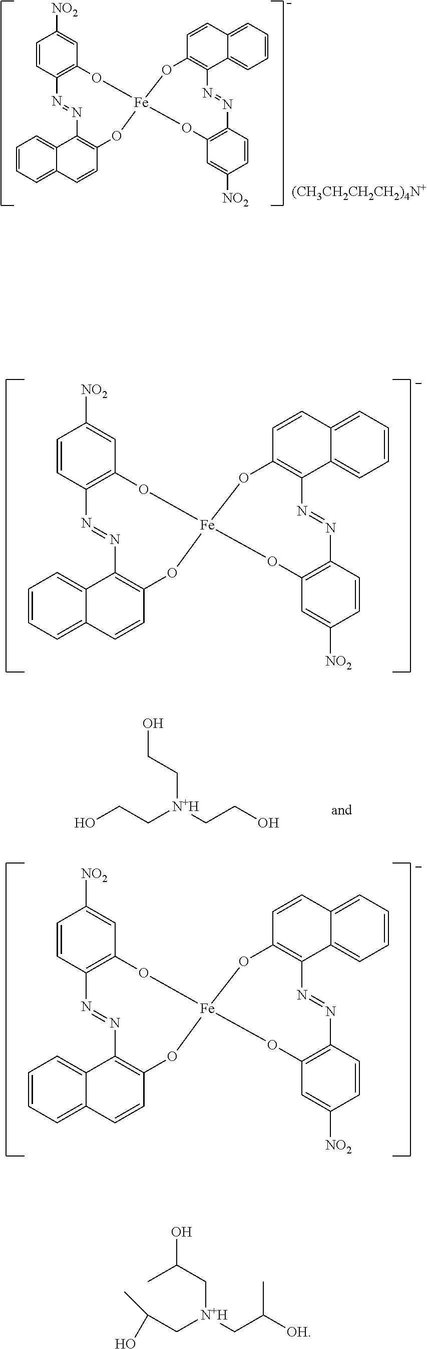

Clause 5. An azo-metal complexed dye compound of clause 1 wherein M is a transition metal in the +3 oxidation state or Al(III).

Clause 6. An azo-metal complexed dye compound of clause 5 wherein M is selected from the group consisting of Fe(III), Al(III), V(III), Mn(III), and Co(III).

Clause 7. An azo-metal complexed dye compound of clause 6 wherein M is Fe(III).

Clause 8. An azo-metal complexed dye compound of any one of clauses 1, 5, 6, or 7 wherein Y and Z are —O—.

Clause 9. An azo-metal complexed dye compound of any one of clauses 1, 2, 3, 5, 6, 7, or 8 wherein X is selected from the group consisting of Na⁺, a secondary amine, a tertiary amine and a quaternary amine.

Clause 10. An azo-metal complexed dye compound of clause 9 wherein X is selected from the group consisting of methylamine, ethylamine, propylamine, isopropylamine, butylamine, sec-butylamine, isobutylamine, pentylamine, tert-pentylamine, 2-aminopentane, 3-aminopentane, 1,2-dimethylpropylamine, mixed isomers of amylamines, hexylamine, heptylamine, 2-ethylhexylamine, octylamine, nonylamine, decylamine, dodecylamine, ethanolamine, propanolamine; isopropanolamine, dimethylamine, diethylamine, dipropylamine, diisopropylamine, diebutylamine, diethanolamine, dipropanolamine, diisopropanolamine, trimethylamine, triethylamine, tripropylamine, tributylamine, triethylamineethanolamine, tri-propanolamine, tri-iso-propanolamine, 2-(2-aminoethoxy)ethanol, tetraethylammonium, tetrabutylammonium, tetrapropylammonium, tetrapentylammonium, tetrahexylammonium, tetraoctylammonium, tetradecylammonium, tetradodecylammonium, tridodecylmethylammonium, dodecyltrimethylammonium, trioctylmethylammonium, benzyltriethylammonium, N-methylethanolamine, N,N-dimethyl-1-propanamine, N,N-dimethylethanolamine, N,N-diisopropylethanolamine, and N,N,N-trimethylethanolamine (choline).

Clause 11. An azo-metal complexed dye compound of any one of clauses 1, 5, 6, 7, 8, 9, or 10 wherein A and A′ independently are selected from the group consisting of

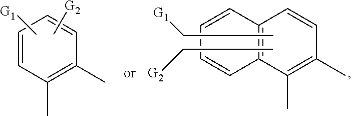

wherein G¹ is hydrogen, halogen, CN, NO₂, CF₃, OR¹, C(O)R⁸, or CO₂R⁸; and G² is hydrogen, halogen, NO₂, linear, branched or cyclic (C₁-C₁₈) alkyl, optionally containing unsaturated bonds and, unsubstituted or substituted aryl or heteroaryl; and wherein R⁸ is hydrogen, optionally substituted linear, branched or cyclic (C₁-C₈) alkyl, optionally substituted aryl or heteroaryl, benzyl, or phenethyl.

Clause 12. An azo-metal complexed dye compound of clause 11 wherein G¹ is Cl or NO₂, and G² is hydrogen, NO₂ or saturated, linear or branched (C₁-C₈) alkyl.

Clause 13. An azo-metal complexed dye compound of clause 11 wherein A and A′ independently are selected from the following o-aminophenols: 2-amino-4-nitrophenol, 2-amino-5-nitrophenol, 2-amino-3,5-dinitrophenol, picramic acid, 2-amino-4-(tert-butyl)-6-nitrophenol, 2-amino-6-nitro-4-(tert-pentyl)phenol, and 2-amino-6-nitro-4-(1,1,3,3-tetramethylbutyl)phenol.

Clause 14. An azo-metal complexed dye compound of any one of clauses 1, 5, 6, 7, 8, 9, 10, 11, or 12 wherein B and B′ independently are

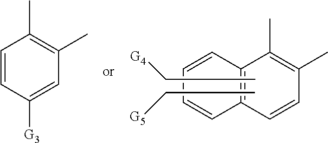

wherein G³ is R¹, halogen; OR¹; NR²R³; G⁴ and G⁵ independently are halogen, hydrogen linear, branched or cyclic (C₁-C₁₈) alkyl, optionally containing unsaturated bonds linear, branched or cyclic (C₁-C₁₈) alkyl, optionally containing unsaturated bonds; or unsubstituted or substituted aryl or heteroaryl. G⁴ and G⁵ preferably are —OR¹, —CO₂R¹, —NR²R³, —NR¹C(O)R⁸, or NR¹C(O)OR⁸.

Clause 15. An azo-metal complexed dye compound of clause 14 wherein G³ is NR²R³, or naphthalene wherein G⁴ is hydrogen, CO₂R⁸, CONHR⁸, OR⁸, NHC(O)R⁸, NHC(O)OR⁸, or substituted or unsubstituted saturated linear or branched (C₁-C₈) alkyl, wherein R⁸ is selected from the group consisting of hydrogen, optionally substituted linear, branched or cyclic (C₁-C₈) alkyl, or optionally substituted aryl or heteroaryl.

Clause 16. An azo-metal complexed dye composition comprising the azo-metal complex dye compound of any one of clauses 1 to 15 and a solvent or suspending agent.

Clause 17. An azo-metal complexed dye composition comprising one or more of the azo-metal complex dye compounds of any one of clauses 1 to 15 and water, a solvent, or a suspending agent.

Clause 18. A water or solvent based ink composition comprising the azo-metal complexed dye compound of any one of clauses 1 to 15.

Clause 19. An ink cartridge comprising the ink composition of clause 18.

Clause 20. A method of inkjet printing comprising using the ink composition of clause 18.

### REFERENCES

All references listed below and throughout the specification are hereby incorporated by reference in their entirety.
1. U.S. Pat. No. 5,314,998.
2. U.S. Pat. No. 7,157,563.
3. U.S. Pat. No. 5,677,434.
4. U.S. Pat. No. 10,023,742.
5. Great Britain Patent No. 2569887.
5. United States Patent Publication No. 2014/0296208.
6. Chinese Patent Application No. 102267916A.
7. J. Org. Chem. 16(6): 988-994, 1957.
8. European Patent No. 531026.
9. Japanese Patent No. 2002275110.
10. U.S. Pat. No. 2,086,854.
11. U.S. Pat. No. 10,876,079.

1. An azo-metal complexed dye compound according to Formula I: 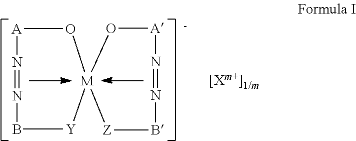
wherein M is any Group 3-13 metal in the 3+ oxidation state, with the proviso that the metal is not Cr(III);
wherein m is the net positive charge on the counter-cation, X.
wherein A and A′ independently are optionally substituted phenylene or naphthylene;
wherein B and B′ independently are optionally substituted phenylene or naphthylene;
wherein Y and Z independently are either —O— or —NR¹—;
wherein X is a hydrogen ion (H⁺), an alkali metal ion, a primary ammonium ion (NH₃R⁴⁺), a secondary ammonium ion (NH₂R⁴R⁵⁺), a tertiary ammonium ion (NHR⁴R⁵R⁶⁺), or a quaternary ammonium ion (NR⁴R⁵R⁶R⁷⁺);
wherein R¹ is
(i) hydrogen;
(ii) a linear, branched or cyclic (C₁-C₁₈) alkyl group, optionally substituted, and optionally containing unsaturated bonds, which contains 0-9 heteroatoms selected from O, N, and S;
(iii) an unsubstituted or substituted aryl, heteroaryl, arylalkyl, heteroarylalkyl, alkylaryl or alkylheteroaryl, wherein the alkyl groups in the arylalkyl, heteroarylalkyl, alkylaryl or alkylheteroaryl moieties are linear, branched or cyclic (C₁-C₁₈) alkyl groups, optionally containing unsaturated bonds, optionally containing 0-9 heteroatoms selected from O, N and S, and optionally containing one or more functional groups selected from —NO₂, —OR², —NR²R³, —CN, —I, —Br, —F, —Cl, —C(O)R², and —CO₂R²;
wherein R² and R³ independently are as defined for R¹, or R² and R³ also may be joined to form a cyclic structure;
wherein R⁴, R⁵, R⁶, and R⁷ independently are
(i) a hydrogen atom;
(ii) a linear, branched or cyclic (C₁-C₁₈) alkyl group, optionally substituted with substituted and unsubstituted alkyl groups, and optionally containing unsaturated bonds;
(iii) a linear, branched, or cyclic (C₁-C₁₈) hetero alkyl group, optionally substituted with substituted and unsubstituted alkyl groups, wherein the hetero atoms are selected from the group consisting of oxygen, nitrogen, sulfur, and silicon, and optionally containing unsaturated bonds;
(iv) an arylalkyl group wherein the alkyl portion of the arylalkyl group is a linear, branched, or cyclic (C₁-C₁₈) alkyl group, optionally substituted with substituted and unsubstituted alkyl groups, and optionally containing unsaturated bonds;
(v) a hetero arylalkyl group optionally substituted with substituted and unsubstituted alkyl groups, wherein the hetero atoms are selected from the group consisting of oxygen, nitrogen, sulfur, and silicon;
(vi) an alkylaryl group wherein the alkyl portion of the arylalkyl group is a linear, branched, or cyclic (C₁-C₁₈) alkyl group, optionally substituted with substituted and unsubstituted alkyl groups, and optionally containing unsaturated bonds;
(vii) a hetero alkylaryl group optionally substituted with substituted and unsubstituted alkyl groups, wherein the hetero atoms are selected from the group consisting of oxygen, nitrogen, sulfur, and silicon; and
(viii) two or more of R⁴, R⁵, and R⁶ optionally are joined to form a cyclic structure.

2. An azo-metal complexed dye compound of claim 1 selected from the group consisting of: 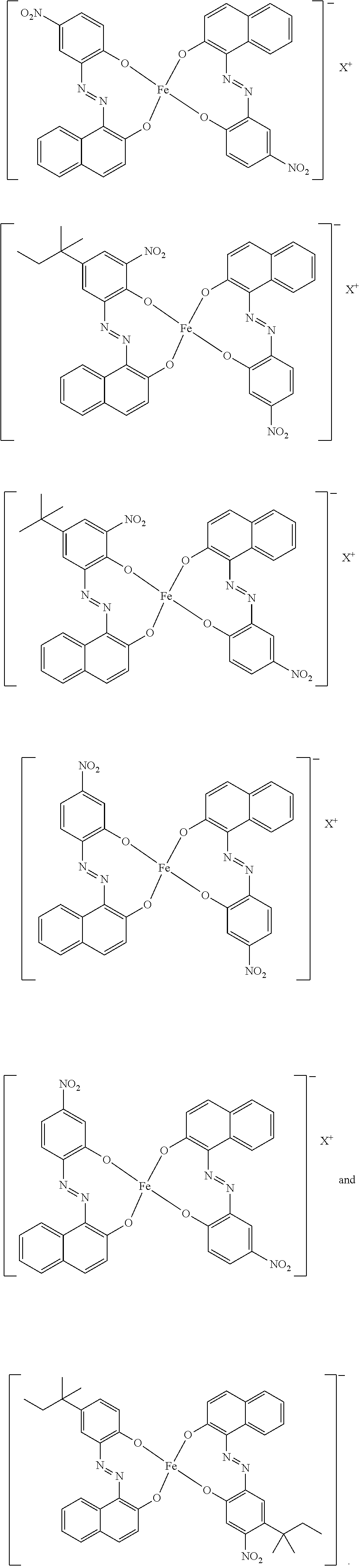
wherein X is a hydrogen ion, an alkali metal ion, a primary ammonium ion, a secondary ammonium ion, a tertiary ammonium ion, or a quaternary ammonium ion.

3. An azo-metal complexed dye compound of claim 1 selected from the group consisting of: 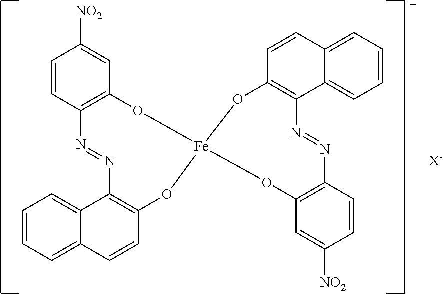
wherein X is a hydrogen ion, an alkali metal ion, a primary ammonium ion, a secondary ammonium ion, a tertiary ammonium ion, or a quaternary ammonium ion.

4. An azo-metal complexed dye compound of claim 1 selected from the group consisting of:

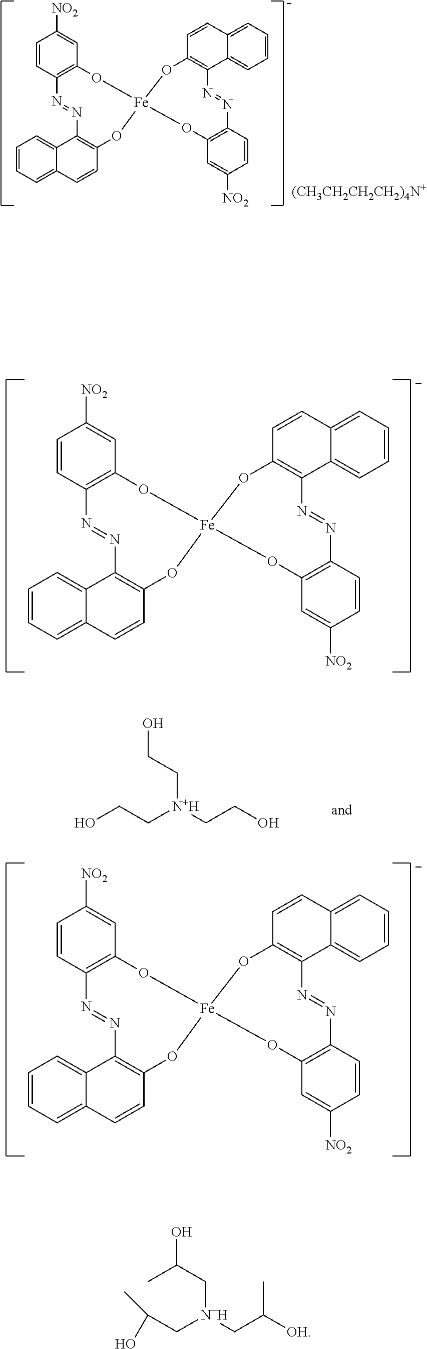

5. An azo-metal complexed dye compound of claim 1 wherein M is a transition metal in the +3 oxidation state or Al(III).

6. An azo-metal complexed dye compound of claim 5 wherein M is selected from the group consisting of Fe(III), Al(III), V(III), Mn(III), and Co(III).

7. An azo-metal complexed dye compound of claim 6 wherein M is Fe(III).

8. An azo-metal complexed dye compound of claim 1 wherein Y and Z are —O—.

9. An azo-metal complexed dye compound of claim 1 wherein X is selected from the group consisting of Na⁺, a secondary amine, a tertiary amine and a quaternary amine.

10. An azo-metal complexed dye compound of claim 9 wherein X is selected from the group consisting of methylamine, ethylamine, propylamine, isopropylamine, butylamine, sec-butylamine, isobutylamine, pentylamine, tert-pentylamine, 2-aminopentane, 3-aminopentane, 1,2-dimethylpropylamine, mixed isomers of amylamines, hexylamine, heptylamine, 2-ethylhexylamine, octylamine, nonylamine, decylamine, dodecylamine, ethanolamine, propanolamine; isopropanolamine, dimethylamine, diethylamine, dipropylamine, diisopropylamine, diebutylamine, diethanolamine, dipropanolamine, diisopropanolamine, trimethylamine, triethylamine, tripropylamine, tributylamine, triethylamineethanolamine, tri-propanolamine, tri-iso-propanolamine, 2-(2-aminoethoxy)ethanol, tetraethylammonium, tetrabutylammonium, tetrapropylammonium, tetrapentylammonium, tetrahexylammonium, tetraoctylammonium, tetradecylammonium, tetradodecylammonium, tridodecylmethylammonium, dodecyltrimethylammonium, trioctylmethylammonium, benzyltriethylammonium, N-methylethanolamine, N,N-dimethyl-1-propanamine, N,N-dimethylethanolamine, N,N-diisopropylethanolamine, and N,N,N-trimethylethanolamine (choline).

11. An azo-metal complexed dye compound of claim 1 wherein A and A′ independently are selected from the group consisting of 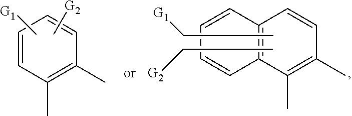
wherein G¹ is hydrogen, halogen, CN, NO₂, CF₃, OR¹, C(O)R⁸, or CO₂R⁸; and G² is hydrogen, halogen, NO₂, linear, branched or cyclic (C₁-C₁₈) alkyl, optionally containing unsaturated bonds and, unsubstituted or substituted aryl or heteroaryl; and wherein R⁸ is hydrogen, optionally substituted linear, branched or cyclic (C₁-C₈) alkyl, optionally substituted aryl or heteroaryl, benzyl, or phenethyl.

12. An azo-metal complexed dye compound of claim 11 wherein G¹ is Cl or NO₂, and G² is hydrogen, NO₂ or saturated, linear or branched (C₁-C₈) alkyl.

13. An azo-metal complexed dye compound of claim 11 wherein A and A′ independently are selected from the following o-aminophenols: 2-amino-4-nitrophenol, 2-amino-5-nitrophenol, 2-amino-3,5-dinitrophenol, picramic acid, 2-amino-4-(tert-butyl)-6-nitrophenol, 2-amino-6-nitro-4-(tert-pentyl)phenol, and 2-amino-6-nitro-4-(1,1,3,3-tetramethylbutyl)phenol.

14. An azo-metal complexed dye compound of claim 1 wherein B and B′ independently are 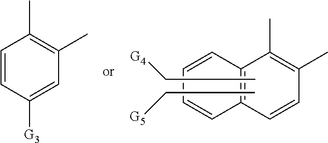
wherein G³ is R¹, halogen; OR¹; NR²R³; G⁴ and G⁵ independently are halogen, hydrogen linear, branched or cyclic (C₁-C₁₈) alkyl, optionally containing unsaturated bonds linear, branched or cyclic (C₁-C₁₈) alkyl, optionally containing unsaturated bonds; or unsubstituted or substituted aryl or heteroaryl. G⁴ and G⁵ preferably are —OR¹, —CO₂R¹, —NR²R³, —NR¹C(O)R⁸, or NR¹C(O)OR⁸.

15. An azo-metal complexed dye compound of claim 14 wherein G³ is NR²R³, or naphthalene wherein G⁴ is hydrogen, CO₂R⁸, CONHR⁸, OR⁸, NHC(O)R⁸, NHC(O)OR⁸, or substituted or unsubstituted saturated linear or branched (C₁-C₈) alkyl, wherein R⁸ is selected from the group consisting of hydrogen, optionally substituted linear, branched or cyclic (C₁-C₈) alkyl, or optionally substituted aryl or heteroaryl.

16. An azo-metal complexed dye composition comprising the azo-metal complex dye compound of claim 1 and a solvent or suspending agent.

17. An azo-metal complexed dye composition comprising one or more of the azo-metal complex dye compounds of claim 1 and water, a solvent, or a suspending agent.

18. A water or solvent based ink composition comprising the azo-metal complexed dye compound of claim 1.

19. An ink cartridge comprising the ink composition of claim 18.

20. A method of inkjet printing comprising using the ink composition of claim 18.
